(19) United States
(12) Patent Application Publication
(10) Pub. No.: US 2012/0002256 A1
(43) Pub. Date: Jan. 5, 2012

(54) Laser Based Image Display System

(76) Inventors: Lilian Lacoste, Gan (FR); Alexander David Corbett, Cambridge (GB); Dominik Stindt, Cambridge (GB)

(21) Appl. No.: 13/201,479

(22) PCT Filed: Feb. 16, 2010
(86) PCT No.: PCT/GB2010/050251

§ 371 Date: Sep. 20, 2011

(30) Foreign Application Priority Data
Feb. 16, 2009 (GB) 0902468.8

(51) Int. Cl. G03H 1/08; G02B 27/28; G03H 1/22; G02B 27/01

(52) U.S. Cl. 359/9; 359/633; 359/489.08; 359/13

(57) ABSTRACT

We describe optical techniques for replicating an image to expand the exit pupil of a head-up laser-based image display system. The system includes image replication optics to replicate an image carried by a substantially collimated beam, the image replication optics comprising a pair of substantially planar reflecting optical surfaces defining substantially parallel planes spaced apart in a direction perpendicular to the parallel planes. The system is configured to launch the collimated beam into a region between the parallel planes such that the reflecting optical surfaces waveguide the beam between the surfaces in a plurality of successive reflections at front and rear optical surfaces. The front optical surface is configured to transmit a proportion of the collimated beam when reflecting the beam such that at each reflection of the collimated beam at the front optical surface a replica of the image is output from the image replication optics.

### CROSS REFERENCE TO RELATED APPLICATION

This application claims priority to PCT Application No. PCT/GB2010/050251 entitled “Laser Based Image Display System” and filed Feb. 16, 2010, which itself claims priority to Great Britain Patent Application No. GB0902468.8 filed Feb. 16, 2009. The entirety of each of the aforementioned applications is incorporated herein by reference for all purposes.

### BACKGROUND OF THE INVENTION

This invention relates to optical techniques for replicating an image, in particular for expanding the exit pupil of a head-up display.

We have previously described techniques for displaying an image holographically—see, for example, WO 2005/059660 (Noise Suppression Using One Step Phase Retrieval), WO 2006/134398 (Hardware for OSPR), WO 2007/031797 (Adaptive Noise Cancellation Techniques), WO 2007/110668 (Lens Encoding), WO 2007/141567 (Colour Image Display), WO 2008/120015 (Head Up Displays), and GB0811729.3 (Head Up Displays). These are all hereby incorporated by reference in their entirety.

In this specification we are particularly concerned with head-up displays (HUDs), although applications of the techniques we describe are not limited to head-up displays. It is generally desirable to expand the exit pupil of a HUD, to provide a large eyebox. There are many existing approaches, each of which has a different set of trade-offs. Broadly speaking the different approaches comprise the use of a phase-only scattering diffuser, the use of a Fresnel image splitter, the use of microlens arrays, and the use of totally internally-reflecting waveguides. In the latter category are the systems described in: WO03/081320; US 2004/0130797; WO 2008/081070; WO 2007/029032; WO 2007/02034; and US 2008/0278812. Further background prior art can be found in US 2008/0192312.

Amongst the above references, the approach by Lumus Limited (US 2008/0278812) describes a device in which is trapped inside a planar substrate by total internal reflection in which, after several reflections from the surfaces of the substrate, the trapped waves reach an array of selectively reflecting surfaces which couple the light out of the substrate into the eye of a viewer. This approach a see-through device but the manufacturing process required is rather complex and the optical efficiency is relatively low. An improvement is described in WO 2007/029032 and WO 2007/029034, the former describing an arrangement which uses a first plate-like waveguide to stretch the horizontal pupil and a second plate-like waveguide to stretch the vertical pupil view. BAe Systems is currently offering a HUD called Q-HUD (Trade Mark) which may employ such techniques. However the manufacturing costs of such an arrangement are again high and the optical efficiency is believed to be relatively low.

Special problems are presented by laser-based image display systems because of the small etendue of laser sources. As the skilled person will understand, broadly speaking etendue is a product of the area of a source and the solid angle subtended by light from the source (as seen from an entrance pupil); more particularly it is an area integral over the surface and solid angle. For a head-up display broadly speaking the etendue is a product of the area of the eyebox and the solid angle of the field of view. As the skilled person will appreciate, the etendue is preserved in a geometrical optical system and hence if a laser is employed to generate the light from which the image is produced absent other strategies the etendue of the system will be small (this can be contrasted with the etendue of a light emitting diode which is large because the emission from and LED is approximately Lambertian). In a laser projection system the light from the laser originates from a small area and has a small initial divergence and it is desirable, especially in a laser-based image display system for a head-up display, to increase the etendue to increase the size of the region over which the displayed imagery may be viewed. One approach is to employ a diffuser to effectively lose the geometric properties of the optical system by projecting and re-imaging the image, but for a head-up display this can result in a very bulky optical arrangement. An alternative approach is to duplicate the displayed image using a pupil expander, and examples of this approach have been outlined above.

There, however, is a need for alternative approaches which address the above drawbacks of existing systems such as those described above and which are adapted for use with laser-based displays and in particular holographic displays of the types we have previously described.

Hence, for at least the aforementioned reasons, there exists a need in the art for advanced systems and methods for display.

### BRIEF DESCRIPTION OF THE DRAWINGS

These and other aspects of the invention will now be further described, by way of example only, with reference to the accompanying Figures in which:

FIG. 1 shows a general arrangement of an example of a head-up display;

FIGS. 2a and 2b show a simple example of a holographic image projection system, and a head-up display variant of the system;

FIG. 3 shows image replication (pupil expander) optics according to an embodiment of the invention;

FIG. 4 shows a graph of polarisation shifts for the retarder of FIG. 3 to achieve substantially uniform replica brightness;

FIG. 5 shows the optical efficiency of a pupil expander with the polarisation shifts of FIG. 4 as a function of the number of replica beams generated;

FIG. 6a shows stacked pupil expanders according to an embodiment of the invention for expanding a beam in two (or more) dimensions; FIGS. 6b and 6c show perspective views of an a pair of stacked image replicators (expanders);

FIG. 7 illustrates a determination of a preferred range of input beam angles to the image replication optics that preserve separated reflection areas;

FIG. 8 shows alternative image replication (pupil expander) optics according to an embodiment of the invention;

FIGS. 9a and 9b show, respectively, a head-up display incorporating a holographic image display system using an optical image replicator according to an embodiment of the invention, and a vehicle rear-view minor incorporating a holographic image display system using an optical image replicator according to an embodiment of the invention;

FIG. 10 shows an experimental arrangement used to test an embodiment of the invention;

FIGS. 11a and 11b show, respectively, a photograph of an experimental version of the display system of FIG. 10, and a photograph of the display system in use showing a plurality of replica images;

FIG. 12 shows details of example replica images;

FIGS. 13a to 13d show, respectively, a block diagram of a hologram data calculation system, operations performed within the hardware block of the hologram data calculation system, energy spectra of a sample image before and after multiplication by a random phase matrix, and an example of a hologram data calculation system with parallel quantisers for the simultaneous generation of two sub-frames from real and imaginary components of complex holographic sub-frame data;

FIGS. 14a and 14b show, respectively, an outline block diagram of an adaptive OSPR-type system, and details of an example implementation of the system; and

FIGS. 15a to 15c show, respectively, a colour holographic image projection system, and image, hologram (SLM) and display screen planes illustrating operation of the system.

### BRIEF SUMMARY OF THE INVENTION

This invention relates to optical techniques for replicating an image, in particular for expanding the exit pupil of a head-up display.

According to a first aspect of the invention there is therefore provided a laser-based image display system, the system comprising: a laser light source to provide light for generating an image; image generating optics coupled to said laser light source to provide a substantially collimated beam bearing an image; and image replication optics to replicate an image carried by said substantially collimated beam, wherein said image replication optics comprises a pair of substantially planar reflecting optical surfaces defining substantially parallel planes spaced apart in a direction perpendicular to said parallel planes, said surfaces comprising a first, front optical surface and a second, rear optical surface, wherein the system is configured to launch said collimated beam into a region between said parallel planes such that said reflecting optical surfaces waveguide said collimated beam between said optical surfaces in a plurality of successive reflections at said first, front and second, rear optical surfaces, and wherein said first, front optical surface is configured to transmit a proportion of said collimated beam when reflecting the beam such that at each reflection of said collimated beam at said front optical surface a replica of said image is output from said image replication optics.

Embodiments of the above described system enable a simpler and cheaper manufacturing process for the image replication optics, as well as providing colour compatibility, and improved optical efficiency.

In embodiments the rear optical surface is a mirrored surface, that is a surface provided with a coating to reflect light. The front optical surface is, in embodiments, a partially transmitting mirrored surface, in embodiments selectively transmitting one polarisation and reflecting another, orthogonal polarisation, in alternative implementations transmitting a proportion of the incident light substantially irrespective of polarisation. Thus although the image replication optics may be fabricated as a bulk optical, for example glass component, in other embodiments the front and rear optical surfaces have an air or gas-filled gap between them—embodiments of the device do not rely upon total internal reflection for their operation. This in turn allows launch angles of the collimated beam into the region between the parallel planes close to a normal to the parallel planes, for example less than 30 o or less than 15 o or less than 10 o to the normal. Furthermore embodiments of the image replication optics are scaleable—that is the distance between the parallel planes may be varied between wide limits. Thus the spacing may be less than 1 mm, 0.5 mm or 0.2 mm or greater than 1 cm, 3 cm or 5 cm; some preferred embodiments, for convenience, have a spacing less than 1 cm between the optical surfaces. In embodiments the lack of transparency of the image replication optics (they are not see-through) does not substantially inhibit the fabrication of a HUD, but merely suggests that where the system is incorporated into a HUD for which a see-through capability is desirable, the image replication optics (pupil expander) should not be the final optical element of the HUD. In some preferred embodiments the holographic image display system that uses the image replication optics as a pupil expansion system to enlarge the eyebox of a HUD.

Experimental work has shown that some of the best results can be obtained when a weak diffuser is used in an intermediate image plane of the system prior to the image replication optics. As described later, exit pupils of the system are tiled in one dimension (for example as stripes) or in or two dimensions (for example, squares or rectangles). An ideal diffuser would diffuse light within one of these exit pupil tiles but would not extend substantially beyond the tile (since light diffused to beyond a tile is effectively lost), albeit a small overlap between tiles in the virtual image plane is desirable. Thus a weak diffuser may diffuse light into a circle or ellipse approximately circumscribing an exit pupil tile.

The circumscribing boundary may be defined by a threshold level of intensity fall off as compared with an light intensity at the centre of the tile or averaged across the tile—for example and 80% or 50% fall-off in intensity. (The intensity can be considered to fall off with angle or distance, depending on whether measurement is made at the diffuser or at the virtual image). Preferably a relatively high threshold, such as 80%, is employed so that a relatively uniform intensity (less than 50%, 40%, 30% or 20% intensity variation) is present across a single tile, and hence across the tiled exit pupil. Thus the weak diffuser is preferably the weakest which gives a desired degree of intensity flatness across the tiled exit pupil.

In one implementation the input beam to the image replication optics is an at least partially polarised beam and the front optical surface is configures to preferentially reflect light of a first (preferably linear) polarisation and to transmit light of a second polarisation orthogonal to the first. Since multiple replications of the input beam are generally desired the image replication optics then preferably also includes a polarisation changing region, more particularly a (directional) phase retarding layer to rotate polarisation of light passing through the layer. For convenience in physical positioning this may be located adjacent the rear optical surface, but functionally it may be located anywhere between the front and rear optical surfaces.

In some particularly preferred configurations light propagating within the waveguide substantially only has the first (reflected) polarisation (except, that is, adjacent the rear reflecting optical surface if this is where the polarisation rotating layer is located). Then, at each reflection from the rear surface (two passes through the polarisation changing region) a component of light at the second, orthogonal polarisation is introduced, which is transmitted through the front optical surface. Preferably the front optical surface reflects substantially no light at the second, orthogonal polarisation.

Broadly speaking in preferred embodiments light propagates in a waveguided fashion through the region between the two reflecting surfaces, alternately reflecting off each surface. Light of the first polarisation is effectively trapped within this wave guiding structure, but on each reflection at the rear surface the polarisation is rotated by a proportion to introduce a corresponding proportion of light at the second polarisation, which escapes from the front surface of the device. The light that is reflected from the front surface is again, therefore, substantially of the first polarisation. Suitable front optical surface reflecting materials exist with a contrast ratio between the two orthogonal polarisations of >1000:1.

Each beam of light transmitted through the front optical surface provides a replica of the image carried by the input beam. It will be appreciated that the intensity of such a replica may straightforwardly be adjusted by adjusting the degree of polarisation change (rotation) introduced by the phase retarding layer. (For a given launch angle of the input beam into the image replication optics the location of the reflection areas can be determined by simple geometry). The polarisation changing region may be provided by a phase retarding layer on the surface of a mirror, or it may comprise a separate optical element, for convenience preferably placed adjacent the rear reflecting surface (although anywhere between the reflectors will suffice). “Continuous” polarisation rotation is preferable technically because it makes tiling without gaps easier. In either case it will be appreciated that different degrees of rotation may be provided by different physical regions of the retarder. Thus in embodiments the polarisation change introduced by the phase retarding layer may be selected to be different for different image replica output beams, to adjust the relative intensities of these beams. More particularly the phase retardation may be chosen so as effectively to compensate for the reduction in brightness of the beam as it reflects back and forth down the waveguide. Still more particularly, the phase retardation may be chosen so as to give some or all of the output (image replica) beams substantially the same brightness.

In embodiments the phase changing region comprises an adjustable phase changing region, for example and electrically adjustable liquid crystal layer. In this way a controllable phase rotation may be introduced to facilitate dynamic control of the brightness of one or more of the output (image replica) beams. Such a device may be referred to as dynamically tunable. This concept can be applied, for example, to tune the system for different laser colours in a multicolour holographic image display system, to tune the brightness or relative brightness of the extracted beams for the different colours or for different viewer's locations.

In some preferred embodiments the holographic image display system comprises a multicolour image display system in which the different colours are displayed in a time multiplexed fashion. However it is not essential to tune the phase retardation for each colour and one advantage of embodiments of the invention is that they are able to perform image replication/pupil expansion for a multicolour display. Nonetheless it may be desirable to tune the system for optimal performance, for example by dynamically adjusting the relative brightness of the colours and/or replica images, in which case a controllable phase retarder or rotator, such as an LCD display without front and back polarisers, positioned over a mirror, may be employed.

This concept can be extended still further, in other aspects of the invention, to construct a display in which an input laser beam (in embodiments, bearing no image) is replicated using image replication optics of the type described above (in either one or two dimensions), the relative intensities of the output beams being controlled according to those desired for the displayed image, the displayed image having, effectively, pixels each corresponding to a potential output beam. Thus, for example, a liquid crystal retarder/rotator may be controlled to switch off all the output beams except a selected beam to illuminate a selected pixel or multiple selected pixels. In this way a novel form of image display device may be constructed.

In an alternative implementation rather than employ polarisation control one of the surfaces, in particular the front surface, is configured as a partially transmissive mirror so that, at each internal reflection down the waveguide, a proportion of the internally reflected beam is transmitted to provide a replicated output image. It has been established by calculation that substantially linear/uniform image with good optical efficiency (>15% for 20 replicas) replication is achievable when the transmission of the partially transmitting mirror is in the range 0.1% to 10%, more particularly 0.3% to 5%. In general the preferred range of percentage transmission will depend on the number of replicas. For example for less than 10 replicas, say N=4 replicas, a suitable transmission range is 10% to 50% transmission (to give a good compromise) whereas above 10 replicas a range of 0.1% to 10% transmission is preferred.

In some preferred implementations of either of the above techniques it has been established that substantially increased optical efficiency can be achieved by stacking two sets of image replication optics one above another so that a replicated beam from a first set of image replication optics provides an input beam to a second set of image replication optics. This technique may be used to replicate beams in one dimension, in which case the or each output beam from one set of image replication optics may provide an input beam to a subsequent set of image replication optics (for example, via an aperture in the subsequent set of image reproduction optics) in which subsequent set of optics the light is waveguided in substantially the same direction as the first set of image replication optics. In this case the second set of image replication optics preferably has a smaller spacing between the planar reflectors than the first set of image replication optics, so that a plurality of output beams is provided from the second set of optics in the physical space between the output beams from the first set of image replication optics (which are the input beams to the second set). This concept may be extended to a third set of image replication optics stacked above the second set in a corresponding manner to that in which the second set is stacked above the first set.

Additionally or alternatively two (or more) sets of image replication optics (pupil expanders) may be stacked such that the direction of light propagation in a first of the expanders is substantially perpendicular to the direction of light propagation in the second expander. In such an arrangement the first expander may provide substantially one-dimensional image (pupil) replication and the second, following expander may provide substantially two-dimensional image (pupil) replication, in particular replicating each of the images from the first expander along an orthogonal direction to the direction of image replication by the first expander.

To achieve this in embodiments a plane defined by the parallel, planar surfaces of the first expander (set of image replication optics) is non-parallel with a plane defined by the parallel, planar surfaces of the second expander (set of image replication optics). However the light exiting the first expander defines a direction or axis which is substantially aligned with the direction or axis of the light exiting the second expander. In this case the spacing of the planes may be the same and in the second set of optics (expander) the light may be propagating in a substantially orthogonal direction to that in which the light is propagating in the first or lower (preceding) set of image replication optics.

When stacking sets of image replication optics preferably successive sets of image replication optics employ different output beam selection approaches, that is one employs a partially transmitting minor surface (to transmit light off any polarisation) whilst the other employs an output mirror surface which is polarisation selective (to transmit a selected polarisation). In preferred embodiments the first image replication optics in a chain along the optical path employs a partially transmitting mirror as the front, output optical surface and the next set of image replication optics employs polarisation selective transmission through the front, output optical surface. In this way the return of light from a second back to a first set of image replication optics is inhibited.

In embodiments the laser-based image display system comprises a holographic image display system projecting an image by illuminating a spatial light modulator (SLM) with the laser light to generate an input beam for the replication optics.

In embodiments a hologram generation processor driving the SLM with hologram data for the desired, displayed image converts input image data to target image data prior to converting to a hologram and compensates for the different scaling of the colour components of the multicolour projected image for replication when calculating this target image. Such compensating may be performed either by effectively scaling a resolution of the displayed holograms proportional to wavelength or by upsizing a colour plane prior to hologram data generation in inverse proportion to wavelength, so that when viewed the holographically generated pixels of the different colour planes appear to have substantially the same pitch.

In embodiments the collimation optics within the system may comprise either or both of beam expansion optics for an illuminating laser and beam expansion optics (a reverse telescope) between the SLM and the image replication optics. In embodiments the input beam is launched into the image replication optics angled away from the normal to the parallel, reflecting planes, for example at greater than 15 degrees, 30 degrees, 45 degrees or 60 degrees to this normal. More generally the angle, ⊖, to the normal is preferably greater than tan−1 (M sin β) where M+1 is a number of replicated output beams and β is a half angle of divergence of the diffracted light from the SLM. (This constraint is related to an implementation with separated reflection areas; in a continuous phase implementation, this constraint is less important).

In embodiments the SLM may be a reflective SLM, for compactness and, optionally, a polarising beam splitter may be employed to divide light incident upon the SLM from the coherent light source from light reflected from the SLM bearing the projected image for replication.

In some particularly preferred embodiments the system includes a processor to receive and process image data to provide hologram data for driving the SLM, the processor being coupled to memory storing processor control code to implement and OSPR (One Step Phase Retrieval)—type procedure. Thus in embodiments an image is displayed by displaying a plurality of temporal holographic subframes on the SLM such that the corresponding projected images (each of which has the spatial extent of a replicated output beam) average in a viewer's eye to give the impression of a reduced noise version of the image for display. It will be appreciated that for these purposes, video may be viewed as a succession of images for display, a plurality of temporal holographic subframes being provided for each image of the succession of images.

In some preferred implementations a head-up display is provided incorporating a laser-based or holographic display system as described above.

In a related aspect the invention provides a method of displaying an image using a laser-based display system, the method comprising: generating an image using a laser light source to provide a beam of substantially collimated light carrying said image; and replicating said image by reflecting said substantially collimated light along a waveguide between substantially parallel planar optical surfaces defining outer optical surfaces of said waveguide, at least one of said optical surfaces being a mirrored optical surface, such that light escapes from said waveguide through one of said surfaces when reflected to provide a replicated version of said image on a said reflection.

Thus in embodiments of the method the rear optical surface is a mirrored surface and the light propagates along the waveguide by reflecting back and forth between the planar parallel optical surfaces, a proportion of the light being extracted at each reflection from the front face. In one implementation this proportion is determined by the transmission of a partially transmitting minor (front surface), as previously described; in another implementation it is provided by controlling a degree of change of polarisation of a beam between reflections at the (front) surface from which it escapes, in this latter case one polarisation being reflected, and an orthogonal polarisation being transmitted, to escape.

As described in the introduction, there is a particular problem in duplicating images in an optical system with a small etendue. Implementations of the display arrangements we describe later employ an LCOS (liquid crystal on silicon) reflective spatial light modulator in conjunction with a polarising beam splitter to separate the input and output beams. The SLM may have a diagonal of less than 5 cm, more particularly less than 3 cm, 2 cm or 1 cm and the angular divergence of the (diffracted) beam from the SLM will generally be less than 3 o more particularly less than 2 o or 1 o. Thus the maximum etendue of such a system will generally be less than 10 mm2 steradian, very likely much less than 5 mm2 steradian, 2 mm2 steradian, or 1 mm2 steradian. (For example, a uniform +/−3 degrees image of 1 cm side square is 0.86 mm2 sr.

In practice the etendue will often be one or two orders of magnitude smaller than these values. It should be noted that in embodiments of the above described laser-based image display system the substantially collimated beam provided to the image replication optics may have a small divergence, for example up to 3 o of divergence, especially if the image replication optics is located relatively close to the laser light source (or SLM in a holographic image display system).

In a further related aspect there is provided an optical image replicator for an image production system having an entendue of less than 1 mm2 steradian, the image replicator comprising a pair of substantially planar reflecting optical surfaces defining substantially, parallel planes spaced apart in a direction perpendicular to said parallel planes, said substantially planar optical surfaces defining outer optical surfaces of a waveguide configured such that light escapes from said waveguide through one of said surfaces when reflected to provide a replicated version of said image on said reflection.

It will be appreciated that in embodiments the optical image replicator may be constructed using discrete optical components, or may be fabricated as a monolithic optical component, for example by defining the components within a continuous block, or a combination of these two approaches may be employed, for example stacking monolithic waveguide components.

In a still further related aspect there is provided an optical replicator comprising a pair of parallel planar optical reflecting surfaces configured to form a cavity within which light can propagate by alternately reflecting off the surfaces, a first one of said surfaces being configured to transmit light of a first polarisation and reflect light of a second, orthogonal polarisation, the second of said surfaces being configured to reflect light of both said polarisations, the optical reflector further comprising a polarisation rotating layer to rotate a polarisation of light at said second polarisation reflected from said first surface to introduce a component at said second polarisation such that when again incident on said first surface said rotated component of light is transmitted.

Two such optical replicators may be stacked to define orthogonal waveguides for replication in two-dimensions. In such an arrangement the second waveguide (counting in a direction in which the light propagates towards the exit) is orthogonal and provides a plurality of rows of replicated output beams; this may comprise a single structure extending in two dimensions over the length of the first waveguide, or a plurality of linear waveguides each extending along a row of replicated output beams.

As previously mentioned, a pixellated image display device may be constructed using such an optical replicator or at least a pair of stacked replicators.

In another application of the optical replicator, a collimated beam, for example from a laser light source, may be replicated to provide a plurality of substantially collimated output beams. Thus in embodiments the optical replicator may be employed to provide a 1- or 2-dimensional matrix light source, for example for telecommunications or lighting purposes. Embodiments of the optical replicator incorporating a controllable polarisation rotating layer such as an electrically addressable liquid crystal material can switch the collimated light beams on and off by controlling the liquid crystal material to selectively add a polarisation component when a beam is to be output.

### DETAILED DESCRIPTION

This invention relates to optical techniques for replicating an image, in particular for expanding the exit pupil of a head-up display.

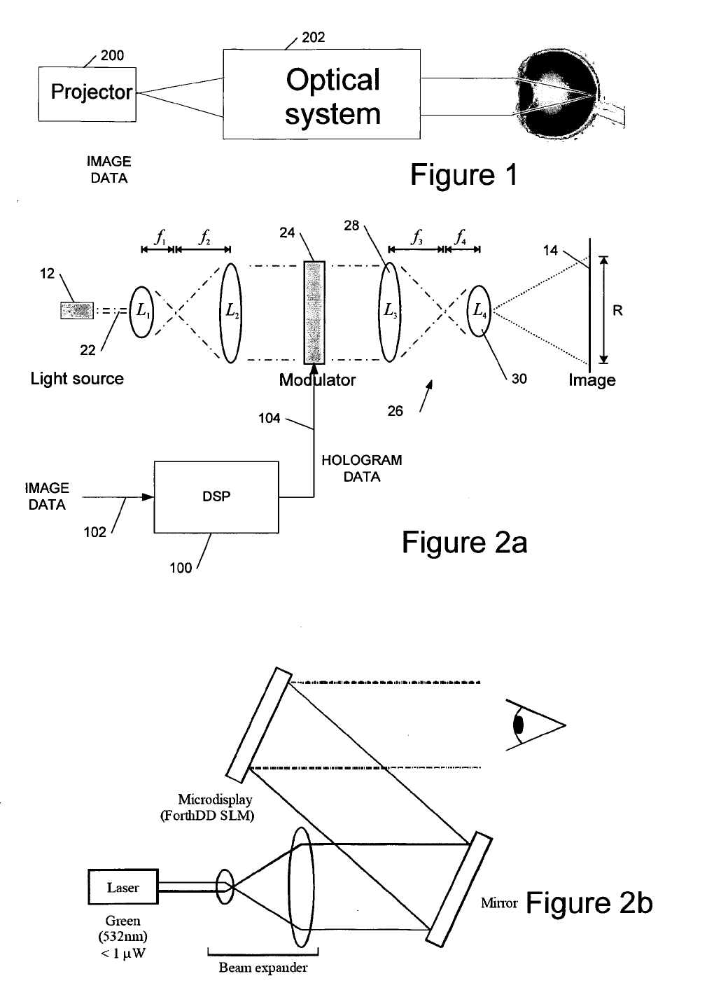

FIG. 1 shows a general arrangement of an example of a head-up display providing a virtual image, the system comprising a projector 200, used as the image source, and an optical system 202 providing a virtual image display at the viewer's retina.

FIG. 2a shows a simple example of a holographic image projection system which may be employed in a head-up display of the type shown in FIG. 1. The system comprises a laser diode 20 which provides substantially collimated light 22 to a spatial light modulator (SLM) 24, via lenses L₁ and L₂ which form a beam-expansion pair so that the light covers the modulator. The light is phase modulated by a hologram displayed on the SLM and provided to a demagnifying optical system 26, as illustrated comprising a pair of lenses (L3, L4) 28, 30 with respective focal lengths f₃, f₄, f₄<f₃, spaced apart at distance f₃+f₄, in effect forming a (demagnifying) telescope. Optical system 26 increases the size of the projected holographic image (replay field R) by diverging the light forming the displayed image, effectively reducing the pixel size of the modulator and thus increasing the diffraction angle. The beam is parallel and substantially collimated (all rays representing the same pixel are parallel)—the diverging rays from L4 show the diffraction angle of the system highly exaggerated. In some arrangements L3 and L4 may be omitted, as shown in the alternative arrangement of FIG. 2b, which depicts a head-up display. A spatial filter may be included to filter out a zero order undiffracted spot or a repeated first order (conjugate) image, where present. The holographic image projection systems of FIG. 2 may be used, for example, for automotive and military head-up displays (HUDs), and 2D near-to-eye displays (in combination with a combiner, not shown in the Figure).

We will describe an optical system able to multiply the exit pupil of an optical system, for example of the type shown in FIG. 2, which produces an image. Embodiments of the pupil expander optics for a HUD have a small volume and can be constructed using COTS (commercial off the shelf) components; an intermediate image plane diffuser need not be employed although use of a weak diffuser can be advantageous, as previously described. Some embodiments use polarised light; the light from a system of the type shown in FIG. 2 may be inherently polarised (for example, if the laser output is polarised), or a polariser may be included in the system, for example a polarising beam splitter in front of a reflective SLM.

### Holographic Image Display Pupil Expander Optical Systems

We will first describe exit pupil expander elements for polarized light imaging producing systems.

The basic principle of this approach is to use a parallel sided waveguide and to extract light based on polarisation—in embodiments of the above described image projection systems the image produced is quite well polarised.

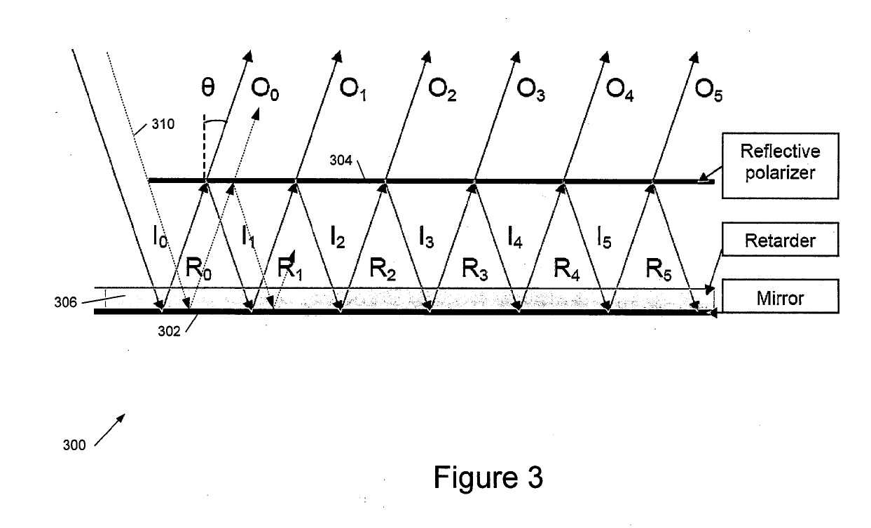

Referring to FIG. 3, this shows an embodiment of a pupil expander (image replication optics) 300 according to an embodiment of the invention. The optics comprises a first substantially planar mirror 302 and a substantially planar reflective polariser 304 substantially parallel to mirror 302 and spaced away from the mirror to form a waveguide. A directional phase retarder 306 is located adjacent to mirror 302. An input beam I₀ launched into the waveguide propagates along the waveguide in a direction parallel to the planes of reflectors 302, 304, alternately reflecting off surfaces 302, 304. The beams reflected off minor 302 are labelled R₀, R₁ and so forth and the beams reflected off polariser 304 are labelled I₁, I₂ and so forth since these can effectively be considered in the same way as beam I₀. At each reflection at the surface of reflective polariser 304 a proportion of the beam is transmitted to form an output beam O₀, O₁ and so forth. In embodiments the reflective polariser reflects light of one polarisation and transmits light of a second, orthogonal polarisation.

A preferred reflective polariser material is that available from Moxtek Inc (Registered Trademark) of Orem, Utah, USA, for example their ProFlux (Trademark) line of polarisers. These reflective polarisers have a particularly advantageous combination of characteristics which make them well suited to embodiments of the invention: they are very efficient (90% transmission of one polarisation, 90% reflection of the other, and achievable contrast of 1:1000), they are very resistant to temperature because of their metallic nature, and they operate well over a wide range of angles (which is often not the case for good reflective polarisers). The material is available in two versions, one preferably operating around normal incidents, the other around 45° incidence.

Thus in more detail the beam I₀ bearing a collimated image is injected into the pupil expander at an angle ⊖ to the normal to the plane of the device. This beam is reflected internally between the two sides of the expander and a small portion of the beam is extracted, at its original injection angle, each time it bounces off the reflective polariser. To achieve this extraction the directional phase retarding layer 306 located inside the waveguide rotates the polarisation of the beam each time the beam passes through it.

Therefore, if we use a complex notation, we can write:

rₖ=μ·e^{j·α}^{ₖ}·iₖ (1)

oₖ=η·j·Im(rₖ) (2)

iₖ₊₁=ρ·Re(rₖ) (3)

We assume that the orientation of the reflective polarizer is selected so that the reflected polarisation is the one of the injected image. In this notation:

iₖ is the intensity incoming beam of order k,

rₖ is the intensity of the reflected beam of order k,

oₖ is the intensity of the outcoming beam of order k,

αₖ the polarisation rotation induced by the retarder at the kth reflection,

μ is the transmission of the retarder+mirror stack,

η is the transmission of the reflecting polarizer,

ρ is the reflection of the reflecting polarizer.

From the first set of equations we can deduce that:

$$\begin{matrix}{i}_{k} = {i}_{0} \cdot {( μ \cdot ρ )}^{k} \cdot {\prod }_{0}^{k - 1} cos ( {α}_{n} ) & ( 4 ) \\ {o}_{k} = {i}_{0} \cdot j \cdot η \cdot {μ}^{k + 1} \cdot {ρ}^{k} \cdot sin ( {α}_{k} ) \cdot {\prod }_{0}^{k - 1} cos ( {α}_{n} ) & ( 5 )\end{matrix}$$

Which in the case of a fixed shift retarder (∀k,αₖ=α) simplifies into:

iₖ=i₀·(μ·ρ)^{k}·cos^{k-1}(α) (6)

oₖ=i₀·j·η·μ^{k+1}·ρ^{k}·sin(α)·cos^{k-1}(α) (7)

This gives a geometrically decreasing intensity of the replicas, by reason of the factor raised to the power k in the above equation:

μ·ρ·cos(α) (8)

This provides a simple validation test for the principle of operation, as described later.

### Image Brightness and Optical Efficiency

We next consider how to make replicas of uniform brightness, and matters relating to the optical efficiency of the system and what influences this efficiency.

From (5) we can express a condition for uniformity of the replicas by:

$$\begin{matrix} {o}_{k} = {o}_{k + 1} & ( 9 ) \\ {i}_{0} \cdot j \cdot η \cdot {μ}^{k + 1} \cdot {ρ}^{k} \cdot sin ( {α}_{k} ) \cdot {\prod }_{0}^{k - 1} cos ( {α}_{n} ) = {i}_{0} \cdot j \cdot η \cdot {μ}^{k + 2} \cdot {ρ}^{k + 1} \cdot sin ( {α}_{k + 1} ) \cdot {\prod }_{0}^{k} cos ( {α}_{n} ) & ( 10 ) \\ sin ( {α}_{k} ) = μ \cdot ρ \cdot sin ( {α}_{k + 1} ) \cdot cos ( {α}_{k} ) & ( 11 )\end{matrix}$$

Leading to the simple following recurrence relation:

tan(αₖ)=μ·ρ·sin(αₖ₊₁) (12)

This means that replica uniformity can be achieved noting the geometrical injection conditions discussed below by providing a pattern in the retarder to achieve this.

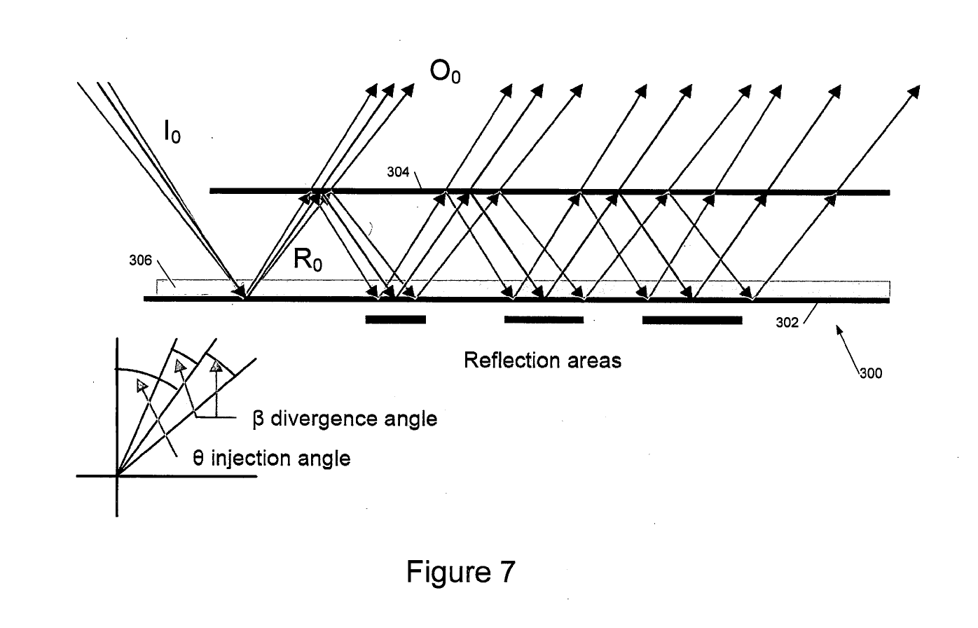

In order to provide a pattern of retardation one straightforward approach is to cut strips of retarder and assemble these together to achieve a desired phase shift. As will be described in more detail later with reference to FIG. 7, a beam propagating down the waveguide of the device reflects at relatively well defined areas on the rear optical surface with gaps in between, typically of millimetric precision. Thus it is straightforward to physically locate different phase retardations at different regions within an optical replicator. Alternatively steps may be etched into a standard optical phase retarder to achieve a desired retardation pattern. In a still further approach an LCD material (without front and back polarisers) may be employed to provide a controllable phase retardation. In embodiments the pattern on the liquid crystal defined by the electrodes may comprise stripes running substantially orthogonal to the average direction of propagation of light as it is waveguided within the optical replicator. Use of a liquid crystal-type material has the advantage that by applying suitable voltages a piecewise-linear approximation to a desired pattern of retardation may be achieved.

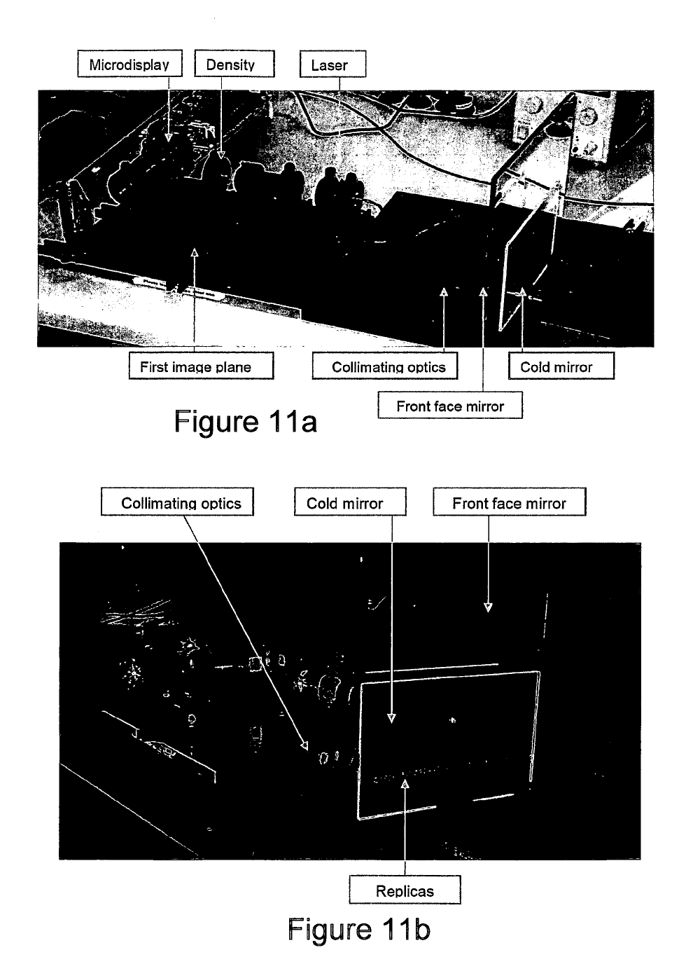

As will be seen from the experimental examples given later (for example FIG. 11b) the replica images may be slightly spaced apart from one another. This can be addressed by launching two or more input beams into the same image replication optics so that the output beams generated by these input beams are interleaved. This mitigates the difficulty of tiling the replicas produced by a single input beam so that their edges align with one another. An advantage of injecting two (or more) input beams is that the replica images can overlap; in the context of the example shown in FIG. 3 this is provided by dashed light beam 310. With such an arrangement it is desirable that there are substantially no gaps between adjacent polarisation changing regions, and use of a liquid crystal material facilitates this. Nevertheless, one must keep in mind that the accuracy of the tiling is determined by the observer's pupil size. In other words, if the exit pupils are tiled with gaps inferior to the observer's pupil, practically the space will appear continuous and improving accuracy will just improve the loss of brightness when passing from one exit pupil to another.

Assuming uniform replicas, we can calculate the maximal efficiency of this element as follows: we know that the maximal efficiency for a uniform output will be reached when we eventually reach the total extraction of the light in the final reflection. This gives the following condition:

$${α}_{N} = \frac{π}{2} \qquad ( 13 )$$

N being the number of replicas that we want to produce.

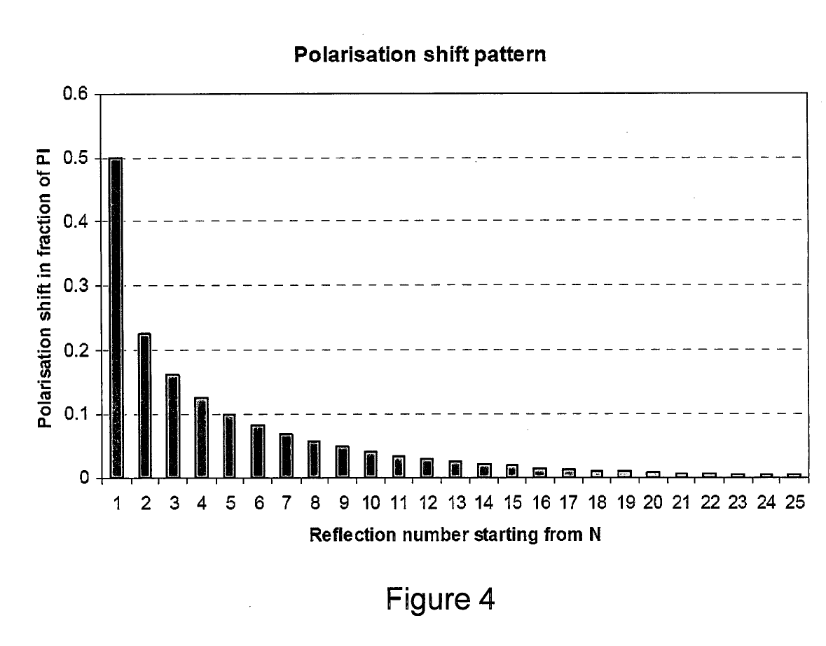

Starting from this boundary, we can compute backwards the values of the different polarisation shifts to achieve uniformity, as shown in FIG. 4.

The graph of FIG. 4 shows the values of the polarisation shifts (αₖ) as fractions of π starting from

$${α}_{N} = \frac{π}{2}$$

and computing backwards αₖ₋₁=arctan(ρ·μ·sin(αₖ)) using the following typical values:

μ=95% is the transmission of the retarder+minor stack,

ρ=90% is the reflection of the reflecting polarizer.

Then if we assume as well that:

η=90% is the transmission of the reflecting polarizer,

We can deduce the total optical efficiency of a pupil expander producing M uniform replicas (where N=M−1) from the following formula:

$$\begin{matrix}{χ}_{M} = \frac{{\sum }_{0}^{M - 1} {‖ {o}_{n} ‖}^{2}}{{‖ {i}_{0} ‖}^{2}} \\ = \frac{M \cdot {‖ {o}_{0} ‖}^{2}}{{‖ {i}_{0} ‖}^{2}} \\ = M \cdot \frac{{‖ {i}_{0} \cdot j \cdot η \cdot μ \cdot sin ( {α}_{0} ) ‖}^{2}}{{‖ {i}_{0} ‖}^{2}} \\ = M \cdot η \cdot μ \cdot {sin}^{2} ( {α}_{0} )\end{matrix} \qquad ( 14 )$$

Considering that, according to the calculation of FIG. 4:

α₀=α_{N+1-M} (15)

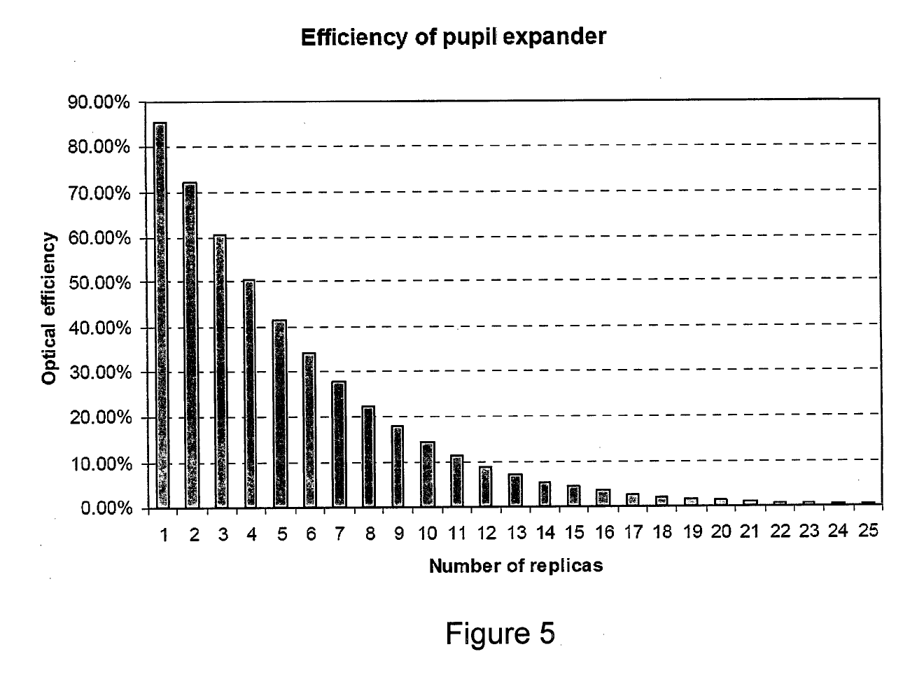

We can directly get the efficiency Figures from the polarisation shift calculations: as shown in FIG. 5.

One can observe from FIG. 5 that, due to the rapid reduction in efficiency when increasing the number of replicas, it appears useful to consider two-pass bi-dimensional expansion rather than a single pass expansion.

For example, assume we would like to magnify the pupil by 16 times, then:

a single pass expansion would lead to an efficiency of 3.37%

a dual pass bi-dimensional expansion would lead to:
a 16.1% efficiency, considering a 2×8 expansion,
a 25.3% efficiency, considering a 4×4 expansion.
   The differences get more dramatic as the magnification gets bigger. For example if we magnify by 36 times:

a single pass expansion would lead to an efficiency of 0.014%

a dual pass bi-dimensional expansion would lead to:
a 1.46% efficiency, considering a 2×18 expansion,
a 5.45% efficiency, considering a 3×12 expansion,
a 9.03% efficiency, considering a 4×9 expansion,
a 11.56% efficiency, considering a 6×6 expansion.

In can also be noted that uniform output can be quite harmful to the total optical efficiency of the system. Broadly, saving light in the first replicas to spread it at the end exposes this light to the exponential loss inside the waveguide. Therefore more is lost than if the majority of light is spread in the first replicas. Practically speaking, this means that it can be worth considering introducing some acceptable non-uniformities in order to improve the total efficiency of the system.

### Multiple Dimension Expansion

Generally speaking, it is a better strategy to make few replicas of a pupil and to replicate this new set of pupils a second time than to make directly and in one “dimension” the number of replicas that it is desired to produce. This is because the efficiency is greatly improved and the optical path difference between the different beams at the output of the pupil expansion device is minimized, which is also desirable.

Thus in embodiments we expand in 2 dimensions (also because the 2D image displayed generally needs to be expanded in 2D eventually). Other strategies can be considered, especially when considering pupil expanders which are as simple to implement as those we describe.

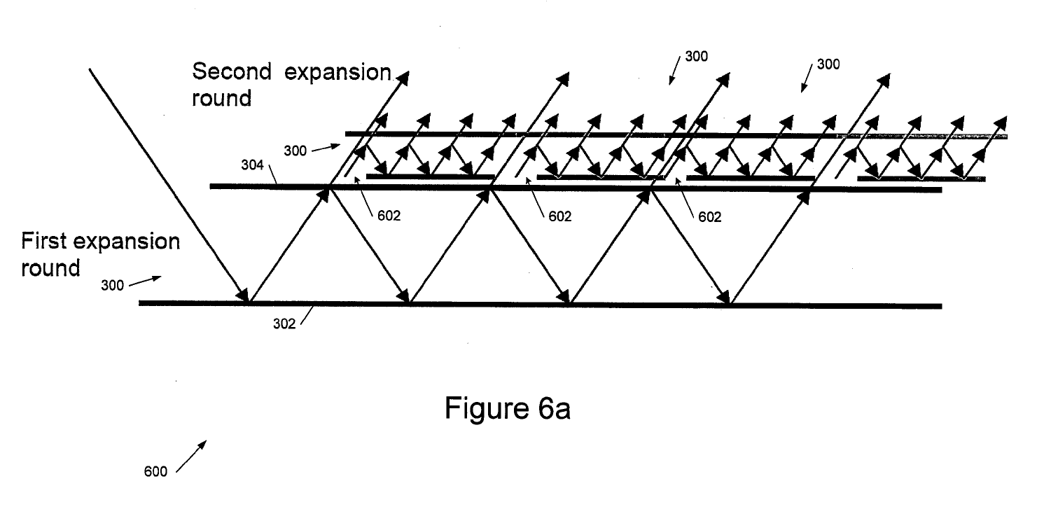

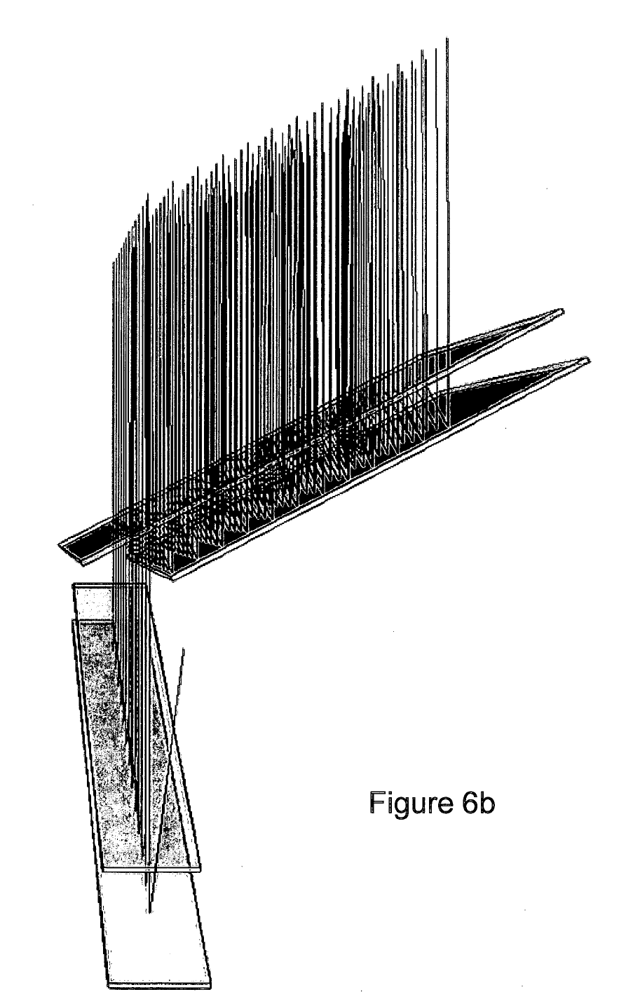

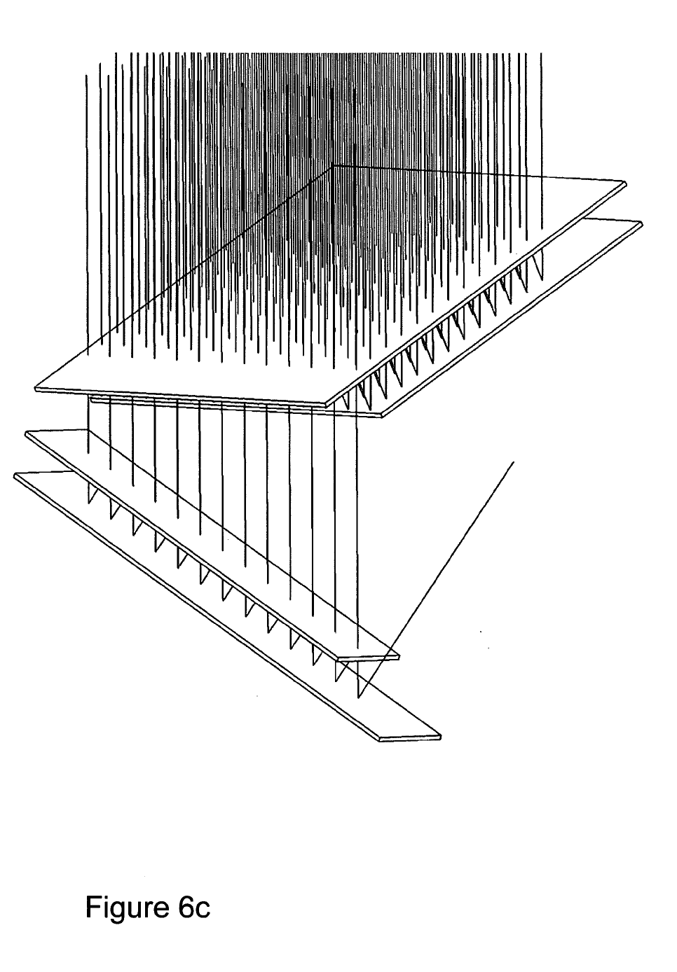

Referring to FIG. 6a this shows a pair of stacked pupil expanders 600 for expanding a beam in two dimensions (in FIG. 6a like elements to those of FIG. 3 are indicated by like reference numerals). In the arrangement of FIG. 6a each output beam from the first image replicator is itself replicated by a second image replicator. Apertures 602 may be provided in the second image replicator(s) for the output beam(s) from the first. FIGS. 6b and 6c show perspective views of an a pair of stacked image replicators (expanders) similar to that of FIG. 6a but, in the illustrated example, with substantially the same spacings between the parallel planes of the two sets of image replicators.

As illustrated in FIG. 6a the second image replicators perform replication in the same direction as the first. However referring to FIGS. 6b and 6c it will be appreciated that, as previously described, for two-dimensional replication the replicators may be stacked such that the direction of light propagation in a first of the expanders is substantially perpendicular to the direction of light propagation in the second expander. In such an arrangement the first expander may provide substantially one-dimensional image (pupil) replication and the second, following expander may provide substantially two-dimensional image (pupil) replication, in particular replicating each of the exit pupils emerging from the first expander along an orthogonal direction to the direction of exit pupil replication by the first expander. As illustrated, a plane defined by the parallel, planar surfaces of the first expander (set of image replication optics) is then in general non-parallel with a plane defined by the parallel, planar surfaces of the second expander (set of image replication optics).

It will be appreciated that the second replicators may be implemented as a single, uni-dimensional replicator with inputs for a plurality of beams to be replicated along one edge. It will also be appreciated that this approach may be extended to stack more than two image replicators to perform N-dimensional replication (the “dimensions” being referred to not necessarily being physical dimensions but rather replication dimensions). For example 2-dimensional replication could be employed to replicate first in one physical dimension and then in a second, orthogonal physical dimension.

In the example illustrated in FIG. 6a the second (upper) image replication system has a different, smaller thickness to the first (lower) replicator. In this way a plurality of output beams may be provided from the second replicator in the physical space between each output beam from the first replicator. In general, for an N-dimensional system, each replica from one layer provides an input beam to a succeeding layer pupil expander of smaller size (smaller distance between the parallel reflecting planes). In practice there will be an upper limit on the number of replicas but, nonetheless, there can be substantial efficiency gains. For example assuming we want to make a 2 dimensional expansion leading to 256 replicas (×16 along one axis, ×16 along another):
If we do this in 2 dimensions we get, according to FIG. 5, an efficiency of 0.11%
If we do this in 4 dimensions (4×4 stacked along one axis and 4×4 stacked along the other), we get an efficiency of 6.4%
   The gain in efficiency is of a factor 56, which suggests that this technique is beneficial at least for a stack of two pupil expanders.

### Geometrical Injection

In a pupil expander for a holographic image projection system the incoming beam, representing a collimated image, is composed of a variety of incoming beams, each direction of which is representing a pixel in the image. Therefore, we can consider that the image is injected in the waveguide with a certain average angle θ around which, the divergence of the beams is ±β as shown in FIG. 7.

Ideally, in order to control full the extraction of the replica by adapting the polarisation shift angle, we should make sure that the different reflection areas along the variety of angles do not overlap.

In order to achieve this separation, assuming an expansion factor of M (M internal reflections), we can derive the following constraint (assuming β is relatively small):

2·M·sin(β)·cos(θ)<2·sin(θ) (16)

M·sin(β)<tan(θ) (17)

From this equation we can deduce that it is preferable if we want to preserve separated reflection areas that θ is not a steep (small) angle, so that tan(θ) is not small.

### Alternative Embodiment

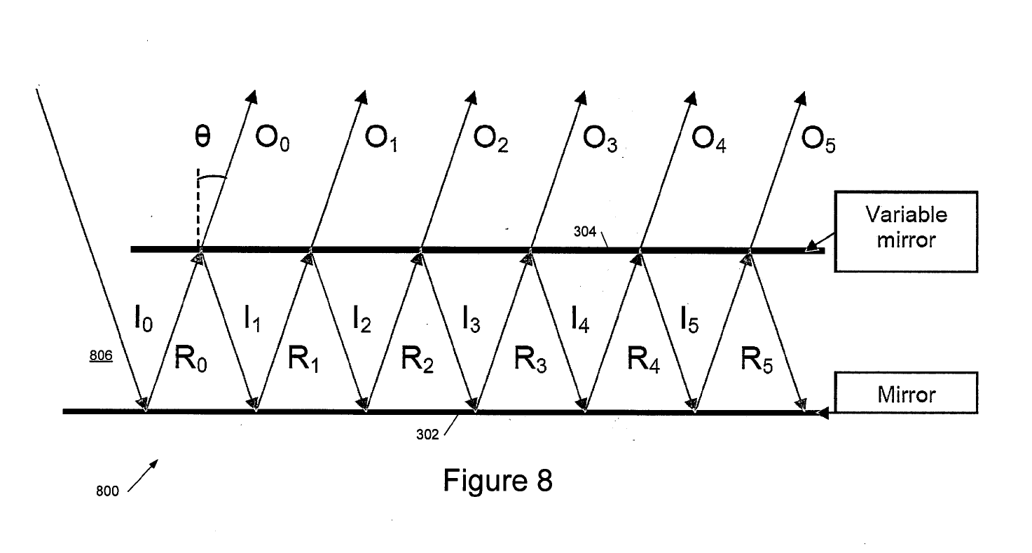

Referring to FIG. 8, this shows an alternative embodiment of a pupil expander (image replication optics) 800 according to the invention. The optics comprise a first, substantially planar minor 802 and a second, substantially planar, partially transmitting minor 804, the two in combination forming a waveguide 806. It has been established that a preferred proportion of light transmitted by mirror 804 depends on the number of replicas desired—for example for 20 replicas along one axis it is between 0.3 and 5%, this range leading to good optical efficiency and good uniformity of the replicated images. In general, the lower the number of replicas, the higher the gradient of transmission and therefore, the higher the final transmission.

In embodiments the pupil expander 800 operates in free space, the fraction of transmitted light through mirror 804 generating a replica image, the remainder of the light (losses apart) continuing to propagate within the cavity. The result described earlier regarding efficiency remain valid for the optimal solution for uniform output and the gradient of reflection versus transmission can be computed based on the result for the reflective polariser output. Which embodiment is preferred may depend upon the desired application.

### Head-Up Displays

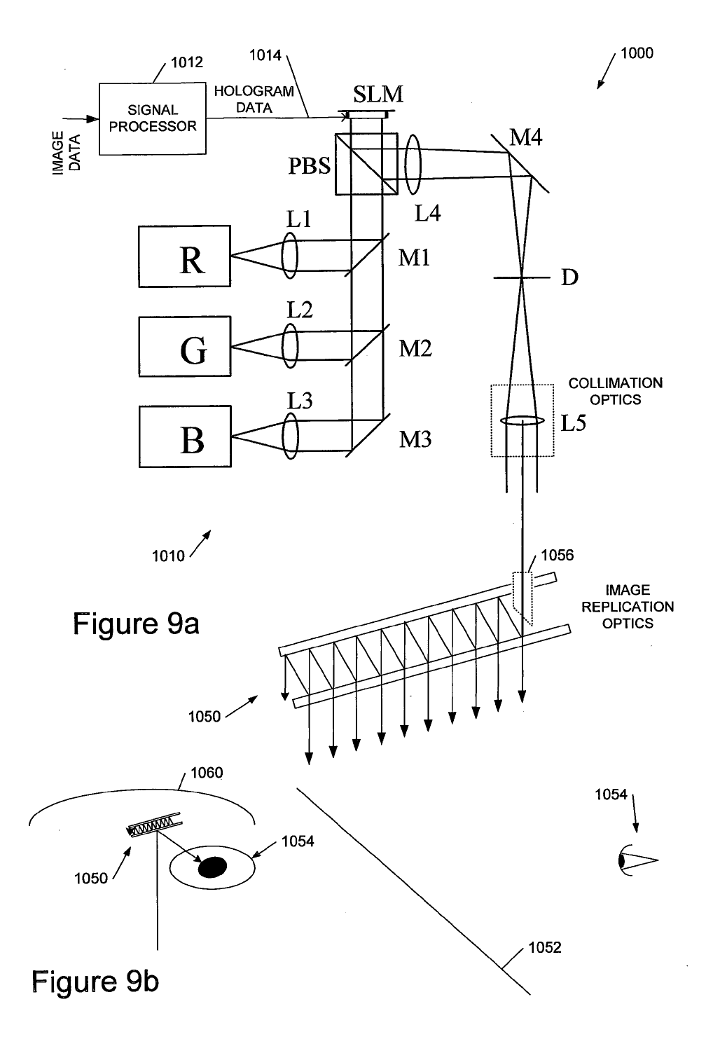

FIG. 9a shows an example of a head-up display (HUD) 1000 comprising a preferred holographic image projection system 1010 in combination with image replication optics 1050 of the type previously described with reference to FIGS. 3-8, and a final, semi-transmissive optical element 1052 to combine the replicated images with an external view, for example for a cockpit display to a user 1054. As illustrated the holographic image projection system 1010 provides a polarised collimated beam to the image replication optics (through an aperture in the rear minor), which in turn provides a plurality of replicated images for viewing by user 1054 via element 1052 which may comprise, for example, a chromatic mirror.

In the example holographic image projector 1010 there are red R, green G, and blue B lasers and the following additional elements:
SLM is the hologram SLM (spatial light modulator). In embodiments the SLM may be a liquid crystal device. Alternatively, other SLM technologies to effect phase modulation may be employed, such as a pixellated MEMS-based piston actuator device.
L1, L2 and L3 are collimation lenses for the R, G and B lasers respectively (optional, depending upon the laser output).
M1, M2 and M3 are corresponding dichroic minors.
PBS (Polarising Beam Splitter) transmits the incident illumination to the SLM. Diffracted light produced by the SLM—naturally rotated (with a liquid crystal SLM) in polarisation by 90 degrees—is then reflected by the PBS towards L4.
Mirror M4 folds the optical path.
Lenses L4 and L5 form an output telescope (demagnifying optics), as with holographic projectors we have previously described. The output projection angle is proportional to the ratio of the focal length of L4 to that of L5. In embodiments L4 may be encoded into the hologram(s) on the SLM, for example using the techniques we have described in WO2007/110668, and/or output lens L5 may be replaced by a group of projection lenses.
D is a weak diffuser, as previously described. It may comprise, for example, a microlens array (MLA) or any other microstructured diffusers. The density of microlenses may be varied to vary the diffusion angle—for example for tiled replicas of 10° angular extent a diffusion angle of 1°-2° is appropriate for the diffused intensity at the edge of a tile to be ˜80% of the intensity at the centre.
A system controller 1012 performs signal processing in either dedicated hardware, or in software, or in a combination of the two, as described further below. Thus controller 1012 inputs image data and touch sensed data and provides hologram data 1014 to the SLM. The controller also provides laser light intensity control data to each of the three lasers to control the overall laser power in the image.

An alternative technique for coupling the output beam from the image projection system into the image replication optics employs a waveguide 1056, shown dashed in FIG. 9a. This captures the light from the image projection system and has an angled end within the image replication optics waveguide to facilitate release of the captured light into the image replication optics waveguide. Use of an image injection element 1056 of this type facilitates capture of input light to the image replication optics over a range of angles, and hence facilitates matching the image projection optics to the image replication optics. Within element 1056 the light propagates by means of total internal reflection.

The arrangement of FIG. 9a illustrates a system in which symbology from the head-up display is combined with an external view, and this is one approach which may be employed to provide a head-up display within a vehicle. Another approach is that schematically illustrated in FIG. 9b, in which like elements to those of FIG. 9a are indicated by light reference numerals. In this example the image replication optics 1050, more particularly the front optical surface of these optics, provides the function of the vehicle rear view minor—that is the image display is incorporated into a vehicle rear-view minor. The front optical surface of the image replication optics 1050 typically has a very high reflectivity, for example better than 95%, and thus provides a particularly high quality rear-view minor whilst the symbology is displayed to the user at an effective image distance of 2 m or greater, so that the accommodation of the users' eye need not change substantially when viewing the reflected image in the rear-view minor and the head-up display symbology. The curved surface 1060 in FIG. 9b schematically illustrates the front windscreen or windshield of a vehicle.

### Experimental Testing

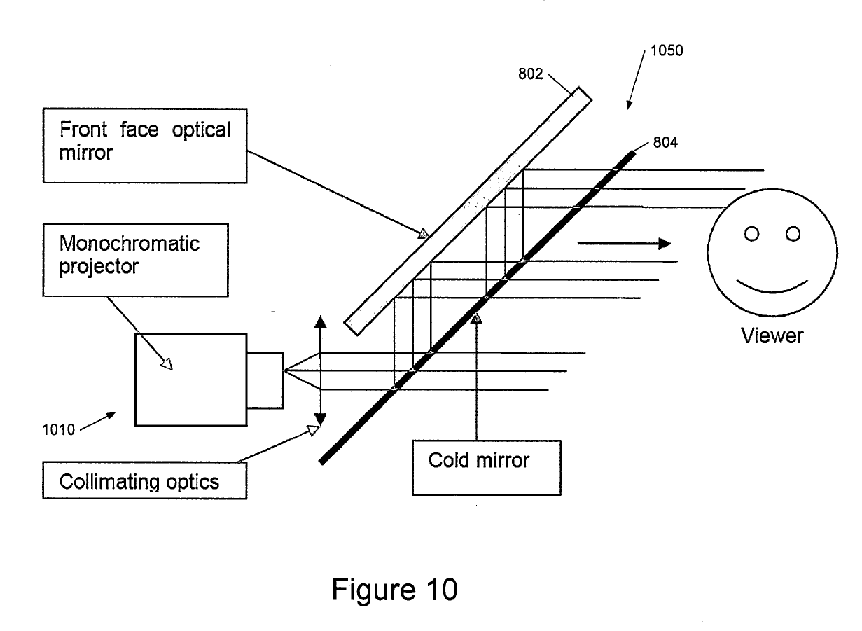

Referring now to FIG. 10, this shows an outline schematic diagram of apparatus used to test the above described image replication optics. The experimental arrangement corresponded to that of a monochrome version of FIG. 9a without the final optical element 1052. Thus in FIG. 10 like elements to those of FIG. 9 are indicated by like reference numerals. The image replication optics in the experiment arrangement used the FIG. 8 embodiment (again like elements are indicated by like reference numerals), the rear optical surface 802 being provided by an optical grade front face mirror, the partially transmitting minor 804 being provided by a so-called cold minor (a minor which reflects visible and transmits infra-red), reflecting approximately 97% of the incident light and transmitting approximately 1% of the incident light. The holographic image projection system and collimation optics were as illustrated in FIG. 9a. The use of a cold mirror enable testing of the principle with a high optical efficiency, only extracting a small percentage of the light at each reflection. In this way one could expect relatively good image intensity uniformity over the first few replicas. A photograph of the experimental arrangement is shown in FIG. 11a.

Referring to FIG. 11b, this shows a photograph of the experimental apparatus in use, illustrating a string of replicas. It can be observed that the degree of uniformity is good, at least for the initial replicas. Depending on the collimation and alignment of the apparatus good tiling of the lower order replicas could be achieved although a gap between replicas is visible with higher order replicas (it is believed this could be improved with improved collimation of the input beam to the image replication optics). The optical efficiency of the system was observed to be good, and experiments suggested that the closer the mirrors the better the system in the sense that closer minors show more closely tiled replicas and less difference in the optical path (to which the apparatus is otherwise sensitive when the collimation is poor). Other observations that can be made from FIG. 11b are that the number of replicas is fairly substantial (36 countable in the photograph) and yet the signal does not vanish (even though it is significantly dimmed towards the end), which illustrates the optical efficiency of the system. The replicas follow more or less a straight line; it is to some degree dependant on the parallelism of the minors, but the sensitivity to the parallelism of the mirrors did not appear to be very great.

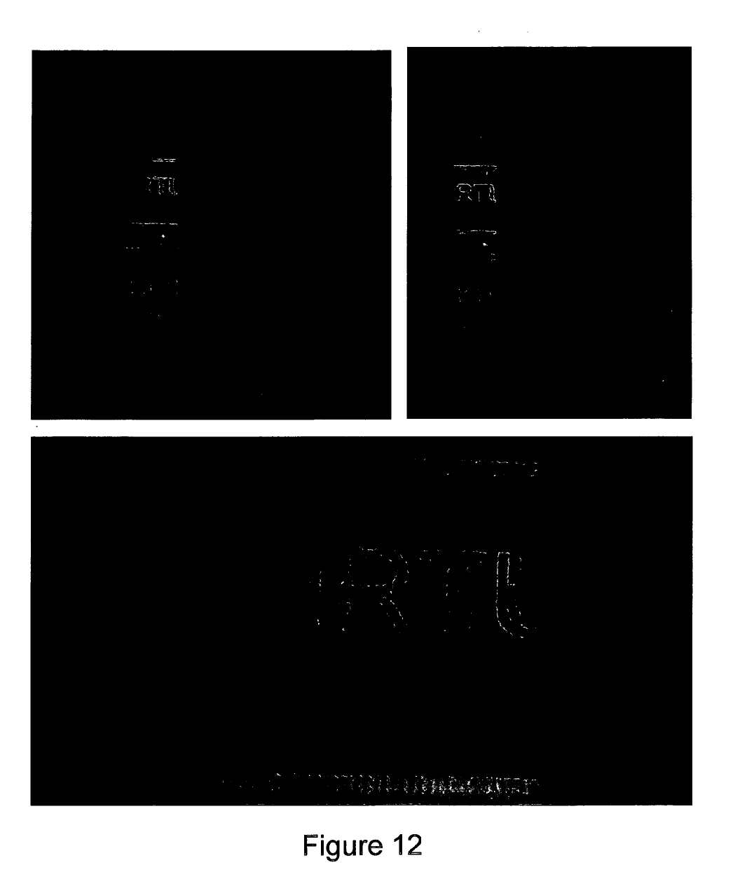

Referring to FIG. 12, this shows photographs of first (left) and higher order (right) replicas from the viewer's side. As illustrated the first image is different to the following replicas, illustrating the need to capture the complete image by the waveguide. Intensity strips are observable, which may be due to multiple reflections causing interference, and an echo is observable, probably from the cold mirror not being anti-reflection coated on its non-reflective side. The reflected view of the experimenter also illustrates reflection from the front surface of the image replication optics

### Hologram Generation

Preferred embodiments of the invention use an OSPR-type hologram generation procedure, and we therefore describe examples of such procedures below. However embodiments of the invention are not restricted to such a hologram generation procedure and may be employed with other types of hologram generation procedure including, but not limited to: a Gerchberg-Saxton procedure (R. W. Gerchberg and W. O. Saxton, “A practical algorithm for the determination of phase from image and diffraction plane pictures” Optik 35, 237-246 (1972)) or a variant thereof, Direct Binary Search (M. A. Seldowitz, J. P. Allebach and D. W. Sweeney, “Synthesis of digital holograms by direct binary search” Appl. Opt. 26, 2788-2798 (1987)), simulated annealing (see, for example, M. P. Dames, R. J. Dowling, P. McKee, and D. Wood, “Efficient optical elements to generate intensity weighted spot arrays: design and fabrication,” Appl. Opt. 30, 2685-2691 (1991)), or a POCS (Projection Onto Constrained Sets) procedure (see, for example, C.-H. Wu, C.-L. Chen, and M. A. Fiddy, “Iterative procedure for improved computer-generated-hologram reconstruction,” Appl. Opt. 32, 5135-(1993)).

### OSPR

Broadly speaking in our preferred method the SLM is modulated with holographic data approximating a hologram of the image to be displayed. However this holographic data is chosen in a special way, the displayed image being made up of a plurality of temporal sub-frames, each generated by modulating the SLM with a respective sub-frame hologram, each of which spatially overlaps in the replay field (in embodiments each has the spatial extent of the displayed image).

Each sub-frame when viewed individually would appear relatively noisy because noise is added, for example by phase quantisation by the holographic transform of the image data. However when viewed in rapid succession the replay field images average together in the eye of a viewer to give the impression of a low noise image. The noise in successive temporal subframes may either be pseudo-random (substantially independent) or the noise in a subframe may be dependent on the noise in one or more earlier subframes, with the aim of at least partially cancelling this out, or a combination may be employed. Such a system can provide a visually high quality display even though each sub-frame, were it to be viewed separately, would appear relatively noisy.

The procedure is a method of generating, for each still or video frame I=I_{xy}, sets of N binary-phase holograms h⁽¹⁾ . . . h^{(N)}. In embodiments such sets of holograms may form replay fields that exhibit mutually independent additive noise. An example is shown below:

$$1. Let {G}_{xy}^{( n )} = {I}_{xy} exp ( {jϕ}_{xy}^{( n )} ) where {ϕ}_{xy}^{( n )} is uniformly distributed$$

$$between 0 and 2 π for 1 \leq n \leq N / 2 and 1 \leq x , y \leq m$$

$$2. Let {g}_{uv}^{( n )} = {F}^{- 1} [ {G}_{xy}^{( n )} ] where {F}^{- 1} represents the$$

$$two \text{-} dimensional inverse Fourier transform operator , for$$

$$1 \leq n \leq N / 2$$

$$3. Let {m}_{uv}^{( n )} = \{ {g}_{uv}^{( n )} \} for 1 \leq n \leq N / 2$$

$$4. Let {m}_{uv}^{( n + N / 2 )} = \{ {g}_{uv}^{( n )} \} for 1 \leq n \leq N / 2$$

$$5. Let {h}_{uv}^{( n )} = \{ \begin{matrix}- 1 & if {m}_{uv}^{( n )} < {Q}^{( n )} \\ 1 & if {m}_{uv}^{( n )} \geq {Q}^{( n )}\end{matrix} where {Q}^{( n )} = median ( {m}_{uv}^{( n )} ) \\ and 1 \leq n \leq N$$

Step 1 forms N targets G_{xy}⁽ⁿ⁾ equal to the amplitude of the supplied intensity target I_{xy}, but with independent identically-distributed (i.i.t.), uniformly-random phase. Step 2 computes the N corresponding full complex Fourier transform holograms gᵤᵥ⁽ⁿ⁾. Steps 3 and 4 compute the real part and imaginary part of the holograms, respectively. Binarisation of each of the real and imaginary parts of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. The median value of mᵤᵥ⁽ⁿ⁾ may be assumed to be zero with minimal effect on perceived image quality.

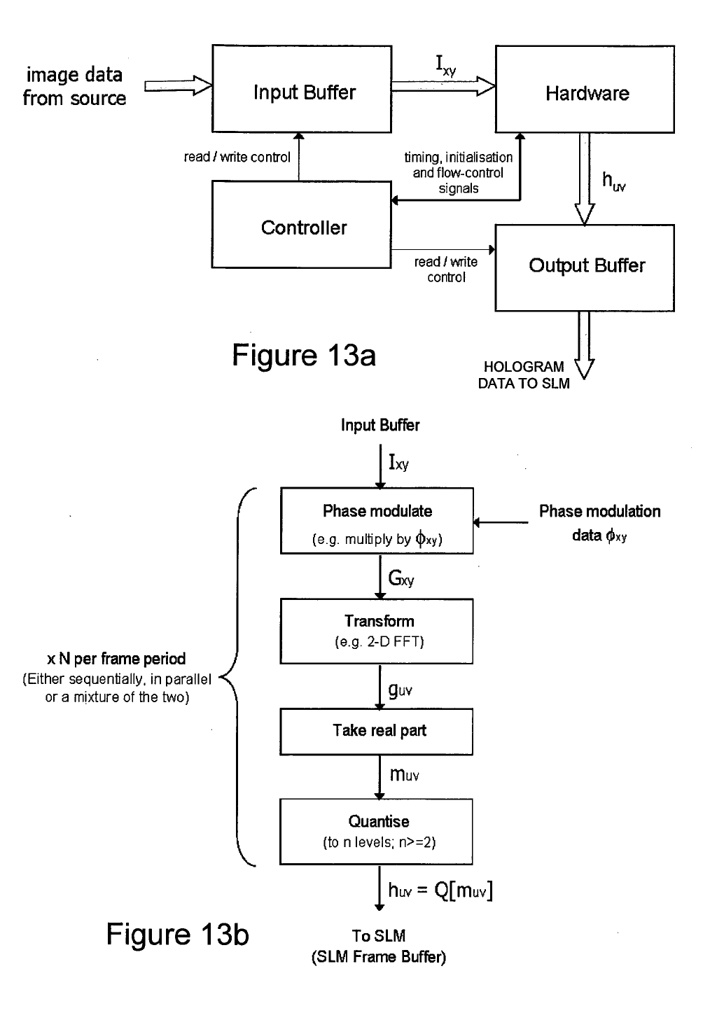

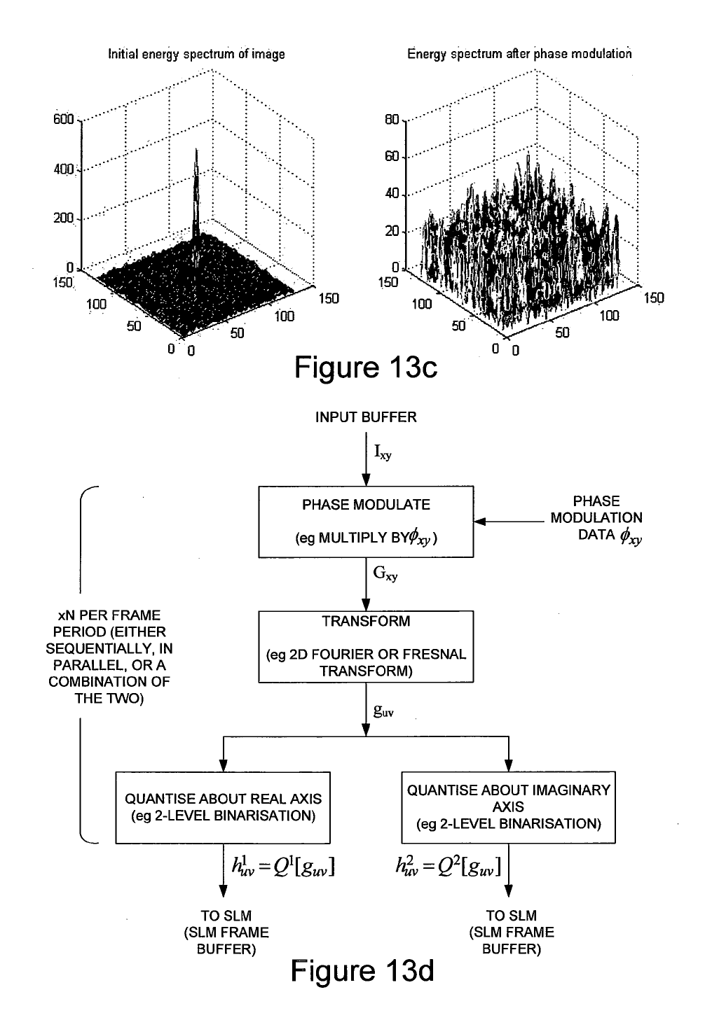

FIG. 13a, from our WO2006/134398, shows a block diagram of a hologram data calculation system configured to implement this procedure. The input to the system is preferably image data from a source such as a computer, although other sources are equally applicable. The input data is temporarily stored in one or more input buffer, with control signals for this process being supplied from one or more controller units within the system. The input (and output) buffers preferably comprise dual-port memory such that data may be written into the buffer and read out from the buffer simultaneously. The control signals comprise timing, initialisation and flow-control information and preferably ensure that one or more holographic sub-frames are produced and sent to the SLM per video frame period.

The output from the input comprises an image frame, labelled I, and this becomes the input to a hardware block (although in other embodiments some or all of the processing may be performed in software). The hardware block performs a series of operations on each of the aforementioned image frames, I, and for each one produces one or more holographic sub-frames, h, which are sent to one or more output buffer. The sub-frames are supplied from the output buffer to a display device, such as a SLM, optionally via a driver chip.

FIG. 13b shows details of the hardware block of FIG. 13a; this comprises a set of elements designed to generate one or more holographic sub-frames for each image frame that is supplied to the block. Preferably one image frame, I_{xy}, is supplied one or more times per video frame period as an input. Each image frame, I_{xy}, is then used to produce one or more holographic sub-frames by means of a set of operations comprising one or more of: a phase modulation stage, a space-frequency transformation stage and a quantisation stage. In embodiments, a set of N sub-frames, where N is greater than or equal to one, is generated per frame period by means of using either one sequential set of the aforementioned operations, or a several sets of such operations acting in parallel on different sub-frames, or a mixture of these two approaches.

The purpose of the phase-modulation block is to redistribute the energy of the input frame in the spatial-frequency domain, such that improvements in final image quality are obtained after performing later operations. FIG. 13c shows an example of how the energy of a sample image is distributed before and after a phase-modulation stage in which a pseudo-random phase distribution is used. It can be seen that modulating an image by such a phase distribution has the effect of redistributing the energy more evenly throughout the spatial-frequency domain. The skilled person will appreciate that there are many ways in which pseudo-random binary-phase modulation data may be generated (for example, a shift register with feedback).

The quantisation block takes complex hologram data, which is produced as the output of the preceding space-frequency transform block, and maps it to a restricted set of values, which correspond to actual modulation levels that can be achieved on a target SLM (the different quantised phase retardation levels may need not have a regular distribution). The number of quantisation levels may be set at two, for example for an SLM producing phase retardations of 0 or π at each pixel.

In embodiments the quantiser is configured to separately quantise real and imaginary components of the holographic sub-frame data to generate a pair of holographic sub-frames, each with two (or more) phase-retardation levels, for the output buffer. FIG. 13d shows an example of such a system. It can be shown that for discretely pixellated fields, the real and imaginary components of the complex holographic sub-frame data are uncorrelated, which is why it is valid to treat the real and imaginary components independently and produce two uncorrelated holographic sub-frames.

An example of a suitable binary phase SLM is the SXGA (1280×1024) reflective binary phase modulating ferroelectric liquid crystal SLM made by CRL Opto (Forth Dimension Displays Limited, of Scotland, UK). A ferroelectric liquid crystal SLM is advantageous because of its fast switching time. Binary phase devices are convenient but some preferred embodiments of the method use so-called multiphase spatial light modulators as distinct from binary phase spatial light modulators (that is SLMs which have more than two different selectable phase delay values for a pixel as opposed to binary devices in which a pixel has only one of two phase delay values). Multiphase SLMs (devices with three or more quantized phases) include continuous phase SLMs, although when driven by digital circuitry these devices are necessarily quantised to a number of discrete phase delay values. Binary quantization results in a conjugate image whereas the use of more than binary phase suppresses the conjugate image (see WO 2005/059660).

### Adaptive OSPR

In the OSPR approach we have described above subframe holograms are generated independently and thus exhibit independent noise. In control terms, this is an open-loop system. However one might expect that better results could be obtained if, instead, the generation process for each subframe took into account the noise generated by the previous subframes in order to cancel it out, effectively “feeding back” the perceived image formed after, say, n OSPR frames to stage n+1 of the algorithm. In control terms, this is a closed-loop system.

One example of this approach comprises an adaptive OSPR algorithm which uses feedback as follows: each stage n of the algorithm calculates the noise resulting from the previously-generated holograms H₁ to Hₙ₋₁, and factors this noise into the generation of the hologram Hₙ to cancel it out. As a result, it can be shown that noise variance falls as 1/N². An example procedure takes as input a target image T, and a parameter N specifying the desired number of hologram subframes to produce, and outputs a set of N holograms H₁ to H_{N} which, when displayed sequentially at an appropriate rate, form as a far-field image a visual representation of T which is perceived as high quality:

An optional pre-processing step performs gamma correction to match a CRT display by calculating T (x, y)^{1.3}. Then at each stage n (of N stages) an array F (zero at the procedure start) keeps track of a “running total” (desired image, plus noise) of the image energy formed by the previous holograms H₁ to Hₙ₋1 so that the noise may be evaluated and taken into account in the subsequent stage: F(x, y):=F(x, y)+|F[Hₙ₋₁(x, y)]|². A random phase factor φ is added at each stage to each pixel of the target image, and the target image is adjusted to take the noise from the previous stages into account, calculating a scaling factor α to match the intensity of the noisy “running total” energy F with the target image energy (T′)². The total noise energy from the previous n−1 stages is given by αF−(n−1)(T′)², according to the relation

$$α := \frac{{\sum }_{x , y} {{T}^{′} ( x , y )}^{4}}{{\sum }_{x , y} F ( x , y ) \cdot {{T}^{′} ( x , y )}^{2}}$$

and therefore the target energy at this stage is given by the difference between the desired target energy at this iteration and the previous noise present in order to cancel that noise out, i.e. (T′)²−[αF−(n−1)(T′)²]=n(T′)²+αF. This gives a target amplitude |T″| equal to the square root of this energy value, i.e.

$${T}^{″} ( x , y ) := \{ \begin{matrix}\sqrt{2 {{T}^{′} ( x , y )}^{2} - α F} \cdot exp \{ jφ ( x , y ) \} & if 2 {{T}^{′} ( x , y )}^{2} > α F \\ 0 & otherwise\end{matrix}$$

At each stage n, H represents an intermediate fully-complex hologram formed from the target T″ and is calculated using an inverse Fourier transform operation. It is quantized to binary phase to form the output hologram Hₙ, i.e.

$$H ( x , y ) := {F}^{- 1} [ {T}^{″} ( x , y ) ]$$

$${H}_{n} ( x , y ) = \{ \begin{matrix}1 & if Re [ H ( x , y ) ] > 0 \\ - 1 & otherwise\end{matrix}$$

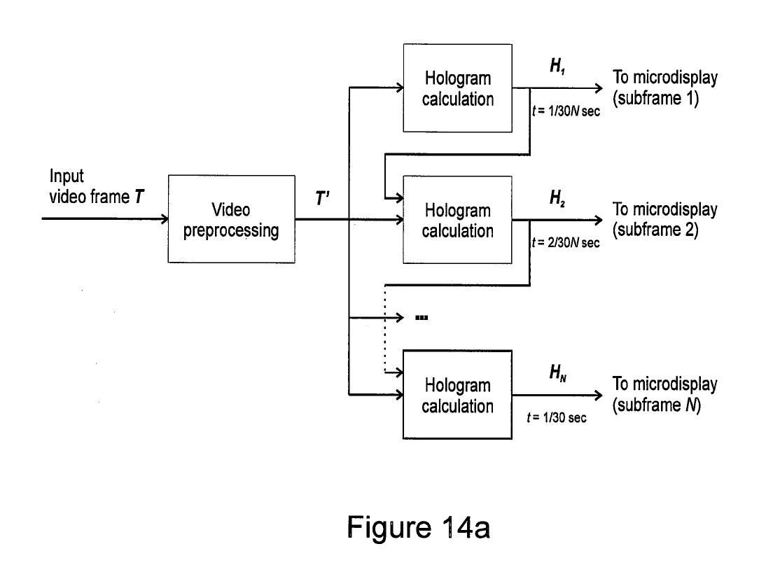

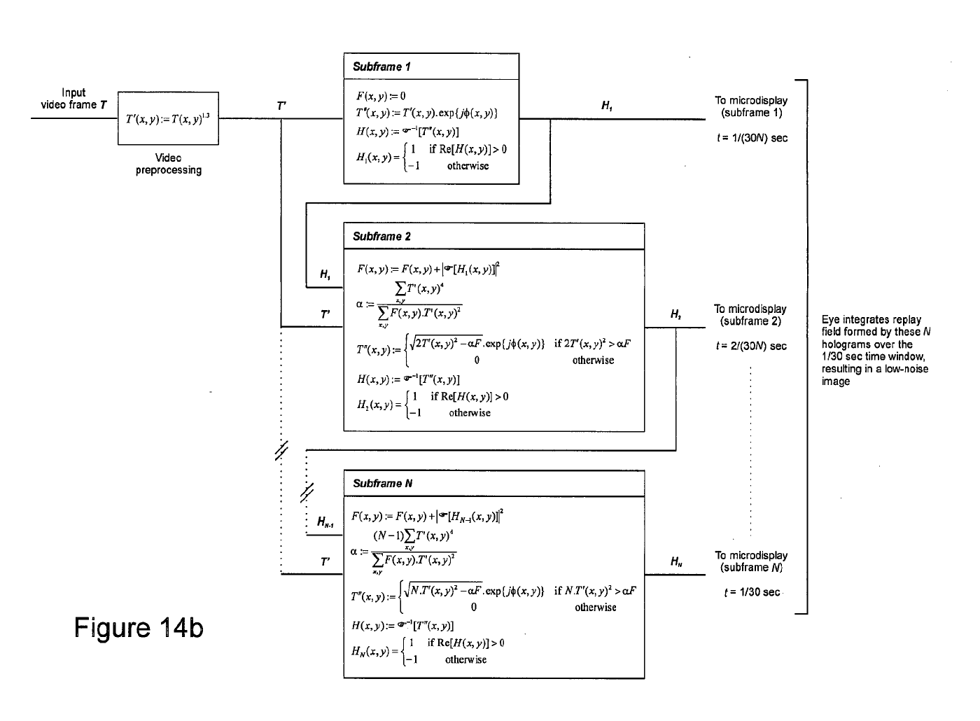

FIG. 14a outlines this method and FIG. 14b shows details of an example implementation, as described above.

Thus, broadly speaking, an ADOSPR-type method of generating data for displaying an image (defined by displayed image data, using a plurality of holographically generated temporal subframes displayed sequentially in time such that they are perceived as a single noise-reduced image), comprises generating from the displayed image data holographic data for each subframe such that replay of these gives the appearance of the image, and, when generating holographic data for a subframe, compensating for noise in the displayed image arising from one or more previous subframes of the sequence of holographically generated subframes. In embodiments the compensating comprises determining a noise compensation frame for a subframe; and determining an adjusted version of the displayed image data using the noise compensation frame, prior to generation of holographic data for a subframe. In embodiments the adjusting comprises transforming the previous subframe data from a frequency domain to a spatial domain, and subtracting the transformed data from data derived from the displayed image data.

More details, including a hardware implementation, can be found in WO2007/141567 hereby incorporated by reference.

### Colour Holographic Image Projection

The total field size of an image scales with the wavelength of light employed to illuminate the SLM, red light being diffracted more by the pixels of the SLM than blue light and thus giving rise to a larger total field size. Naively a colour holographic projection system could be constructed by superimposed simply three optical channels, red, blue and green but this is difficult because the different colour images must be aligned. A better approach is to create a combined beam comprising red, green and blue light and provide this to a common SLM, scaling the sizes of the images to match one another.

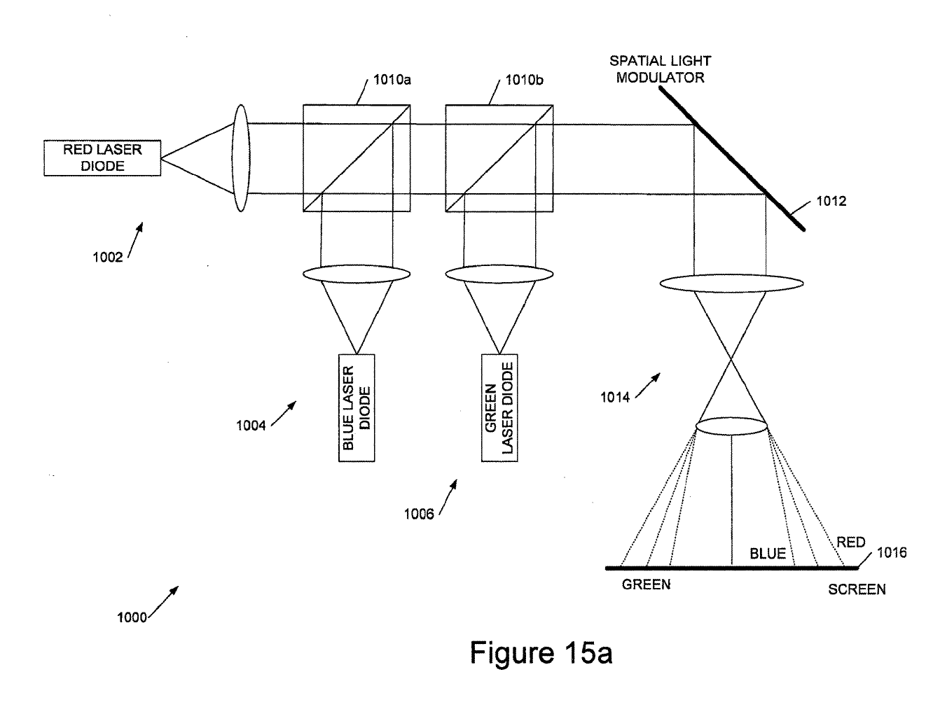

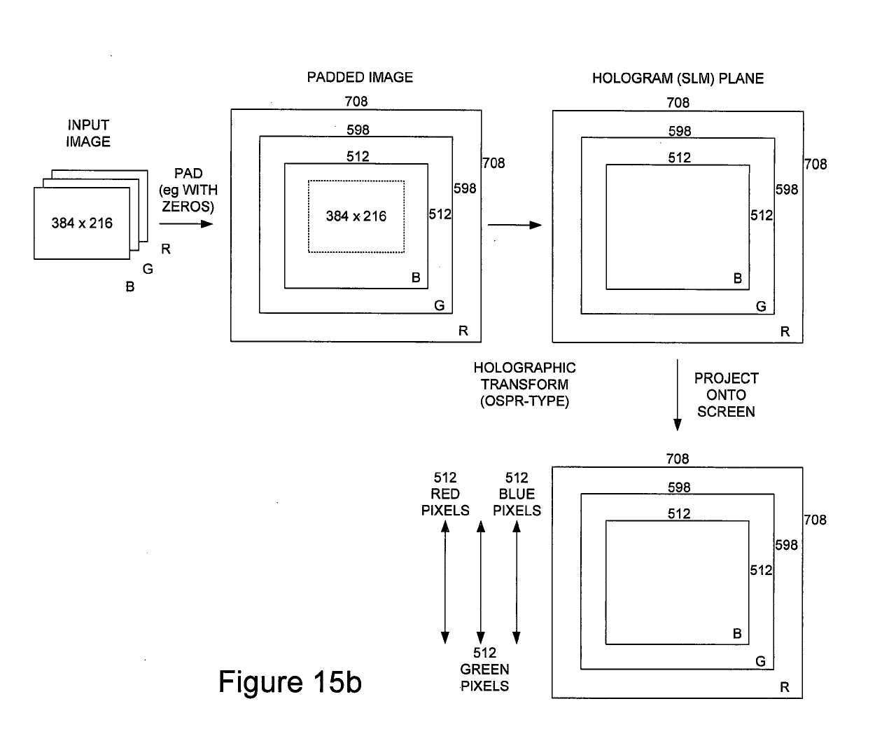

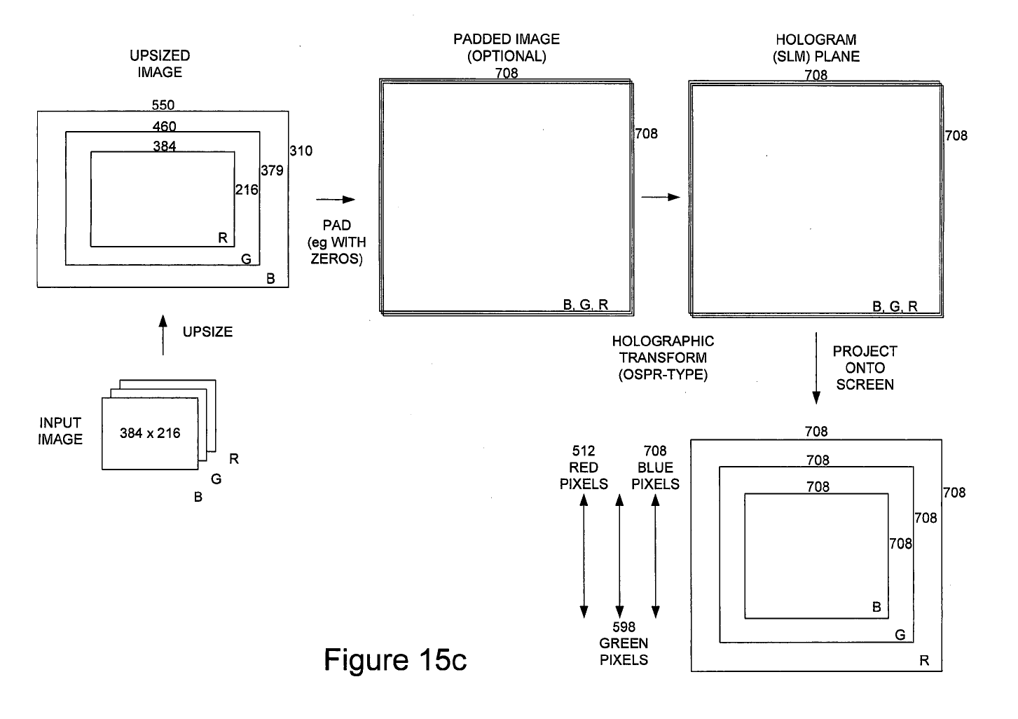

FIG. 15a shows an example colour holographic image projection system 1000, here including demagnification optics 1014 which project the holographically generated image onto a screen 1016. The system comprises red 1002, green 1006, and blue 1004 collimated laser diode light sources, for example at wavelengths of 638 nm, 532 nm and 445 nm, driven in a time-multiplexed manner. Each light source comprises a laser diode 1002 and, if necessary, a collimating lens and/or beam expander. Optionally the respective sizes of the beams are scaled to the respective sizes of the holograms, as described later. The red, green and blue light beams are combined in two dichroic beam splitters 1010a, b and the combined beam is provided (in this example) to a reflective spatial light modulator 1012; the Figure shows that the extent of the red field would be greater than that of the blue field. The total field size of the displayed image depends upon the pixel size of the SLM but not on the number of pixels in the hologram displayed on the SLM.

FIG. 15b shows padding an initial input image with zeros in order to generate three colour planes of different spatial extents for blue, green and red image planes. A holographic transform is then performed on these padded image planes to generate holograms for each sub-plane; the information in the hologram is distributed over the complete set of pixels. The hologram planes are illuminated, optionally by correspondingly sized beams, to project different sized respective fields on to the display screen. FIG. 15c shows upsizing the input image, the blue image plane in proportion to the ratio of red to blue wavelength (638/445), and the green image plane in proportion to the ratio of red to green wavelengths (638/532) (the red image plane is unchanged). Optionally the upsized image may then be padded with zeros to a number of pixels in the SLM (preferably leaving a little space around the edge to reduce edge effects). The red, green and blue fields have different sizes but are each composed of substantially the same number of pixels, but because the blue, and green images were upsized prior to generating the hologram a given number of pixels in the input image occupies the same spatial extent for red, green and blue colour planes. Here there is the possibility of selecting an image size for the holographic transform procedure which is convenient, for example a multiple of 8 or 16 pixels in each direction.

In addition to head-up displays, the techniques described herein have other applications which include, but are not limited to, the following: mobile phone; PDA; laptop; digital camera; digital video camera; games console; in-car cinema; navigation systems (in-car or personal e.g. wristwatch GPS); head-up and helmet-mounted displays for automobiles and aviation; watch; personal media player (e.g. MP3 player, personal video player); dashboard mounted display; laser light show box; personal video projector (a “video iPod®” concept); advertising and signage systems; computer (including desktop); remote control unit; an architectural fixture incorporating a holographic image display system; more generally any device where it is desirable to share pictures and/or for more than one person at once to view an image.

Embodiments of the above-described optical architectures are optically efficient, scalable, colour compatible and based on inexpensive, off-the-shelf optical components. Embodiments do not rely upon totally internal reflection, which facilitates free choice of an injection angle into the image replication optics, including injection angles close to normal. Although embodiments are not used on-axis (the viewer should be centred around a direction parallel to the injection direction), this could be addressed by use of a prism or some equivalent optical device.

No doubt many other effective alternatives will occur to the skilled person. It will be understood that the invention is not limited to the described embodiments and encompasses modifications apparent to those skilled in the art lying within the spirit and scope of the claims appended hereto.

In conclusion, the invention provides novel systems, devices, methods and arrangements for display. While detailed descriptions of one or more embodiments of the invention have been given above, no doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. A method of displaying an image, the method comprising:
generating an image;
providing a beam of substantially collimated light carrying said image; and
replicating said image by reflecting said substantially collimated light along a waveguide between substantially parallel planar optical surfaces defining outer optical surfaces of said waveguide, at least one of said optical surfaces being a mirrored optical surface, such that light escapes from said waveguide through one of said surfaces when reflected to provide a replicated version of said image on a said reflection.

2. A method as claimed in claim 1 wherein said optical surfaces comprise a front and a rear optical surface of said waveguide, wherein said light escapes through said front optical surface, wherein said light is polarised light, and wherein said front optical surface is configured to reflect light of a first polarisation and transmit light of a second, orthogonal polarisation, the method further comprising rotating a polarisation of light of said first polarisation from said front optical surface on reflection at said rear optical surface to introduce a component of light at said second polarisation for transmission through said front optical surface when said light reflected at said rear optical surface is next incident on said front optical surface.

3. A method as claimed in claim 1 wherein said optical surfaces comprise a front and a rear optical surface of said waveguide, wherein said light escapes through said front optical surface, and wherein said front optical surface comprises a partially transmitting minor with a transmission of between 0.1% and 10%, more preferably between 0.3% and 5%.

4. An optical image replicator for an image production system, the image replicator comprising a pair of substantially planar reflecting optical surfaces defining substantially, parallel planes spaced apart in a direction perpendicular to said parallel planes, said substantially planar optical surfaces defining outer optical surfaces of a waveguide configured such that light escapes from said waveguide through one of said surfaces when reflected to provide a replicated version of said image on said reflection; wherein said optical surfaces comprise a first, front optical surface and a second, rear optical surface, wherein said first, front optical surface is configured to transmit a proportion of light when reflecting light such that said light escapes through said front optical surface.

5. An optical image replicator as claimed in claim 4 for an image production system having an entendue of less than 10 mm² steradian, 5 mm² steradian or 1 mm² steradian.

6. An optical image replicator as claimed in claim 4 wherein said front optical surface is configured to preferentially reflect light of a first polarisation and to preferentially transmit light of a second polarisation orthogonal to said first polarisation, and further comprising a polarisation changing region between said first and second optical surfaces.

7. An optical image replicator as claimed in claim 6 wherein said first and second polarisations comprise linear polarisations, and wherein said polarisation changing region comprises a phase retarding layer to rotate a polarisation of light passing through the layer, in particular wherein a phase retardation of said phase retarding layer varies along a direction defined by an average direction of waveguided propagation of light between said optical surfaces.

8. An optical image replicator as claimed in claim 7 wherein said phase retarding layer is configured to rotate the polarisation of light reflected from said second, rear surface to introduce a component of said light at said second polarisation, and wherein said component of light at said second polarisation is transmitted through said first, front optical surface such that light reflected from said first, front optical surface has substantially only said first polarisation.

9. An optical image replicator as claimed in claim 6, wherein said phase changing region comprises an electrically addressable liquid crystal layer to provide a controllable polarisation rotation.

10. An optical image replicator as claimed in claim 4 comprising at least two said pairs of substantially planar, parallel spaced apart optical surfaces, each of said pairs of optical surfaces defining a respective said waveguide, each said waveguide being configured to guide light on average in substantially the same direction, each said waveguide having a respective said front optical surface and a said rear optical surface, and wherein said front optical surface of a first said waveguide is configured to provide an input beam to a said rear optical surface of a said second waveguide such that a light beam escaping from said front optical of said first waveguide is reflected a plurality of times along said second waveguide to provide a plurality of second waveguide output beams, and wherein a spacing between said optical surfaces of said second waveguide is less than a spacing between said optical surface of said front waveguide.

11. An optical image replicator as claimed in claim 10 comprising a plurality of said second waveguides, and wherein said plurality of second said waveguides share a common said front optical surface and a common said rear optical surface.

12. An optical image replicator as claimed in claim 4 wherein said image is provided by a beam of substantially collimated, substantially polarised light; further comprising pupil expander optics for an image production system.

13. An optical image replicator as claimed in claim 4 further comprising said image production system, wherein said image production system includes a controllable spatial light modulator to display a hologram in accordance with hologram data provided to said spatial light modulator, and wherein said optical image replicator is configured to replicate an image formed by illumination of said displayed hologram with coherent light.

14. An optical image replicator as is claim 12, wherein the optical image replicator is implemented as part of a head up display.

15. An optical replicator comprising a pair of parallel planar optical reflecting surfaces configured to form a cavity within which light can propagate by alternately reflecting off the surfaces, a first one of said surfaces being configured to transmit light of a first polarisation and reflect light of a second, orthogonal polarisation, the second of said surfaces being configured to reflect light of both said polarisations, the optical reflector further comprising a polarisation rotating layer to rotate a polarisation of light at said second polarisation reflected from said first surface to introduce a component at said second polarisation such that when again incident on said first surface said rotated component of light is transmitted.

16. A pair of stacked optical replicators each as claimed in claim 15, one to replicate an output beam of the other, and wherein a second of said optical replicators has more closely spaced said parallel planar reflecting surfaces than said a first of said optical replicators.

17. An optical replicator as claimed in claim 15 wherein said second surface is provided with a polarisation rotating layer adjacent said second surface.

18. An optical replicator as claimed in claim 15, wherein said polarisation rotating layer comprises a layer of electrically addressable liquid crystal material.

19. An optical replicator as claimed in claim 15, wherein control of a phase retardation or polarisation rotation of said liquid crystal material controls brightness of illumination of pixels of a pixellated image display device.

20. An optical image replicator as claimed in claim 4, wherein two of said waveguides are stacked such that a first image replication is performed substantially one-dimensionally and a second, following replication provides substantially two-dimensional image replication, replicating each of the images from the first replication along an orthogonal direction to a direction of image replication by the first replication, and wherein replicated image-carrying beams from said first and second replications are substantially aligned along a common direction.
